(19) United States
(12) Patent Application Publication
(10) Pub. No.: US 2019/0257581 A1
(43) Pub. Date: Aug. 22, 2019

(54) SYSTEMS AND METHODS FOR PROCESSING CEREAL GRASSES

(71) Applicant: BioFilm IP, LLC, Minden, NV (US)

(72) Inventors: Daniel X. Wray, Minden, NV (US); Ericson C. CENICEROS, Reno, NV (US); Reed Nicholas LIU, Reno, NV (US); Olivia TANGUILEG, Reno, NV (US); Seth THOMPSON, Rohnert Park, CA (US); Benjamin WALLACE, Henderson, NV (US); Anthony ZUNINO, Reno, NV (US)

(21) Appl. No.: 16/346,473

(22) PCT Filed: Nov. 1, 2017
(86) PCT No.: PCT/US2017/059595

§ 371 Date: Apr. 30, 2019

Related U.S. Application Data
(60) Provisional application No. 62/416,627, filed on Nov. 2, 2016.

(51) Int. Cl. F26B 1/00; F26B 17/02; F26B 5/14

(52) U.S. Cl. CPC F26B 1/005; F26B 2210/10; F26B 5/14; F26B 17/02

(57) ABSTRACT

Provided are systems and methods for drying a cereal grass, such as alfalfa, barley, clover, rye grass, Timothy grass, and the stalks, stems, grains and leaves of a cereal grass, such as oats, wheat, buckwheat, maize, millet, rice and sorghum. The systems include a first pressing roll and a second pressing roll that form a nip through which the cereal grass or forage crop can be pressed, pressing the liquid out of the cereal grass or forage crop to form a first product stream comprising a dewatered cereal grass or forage crop and a second product stream comprising liquid pressed out of the cereal grass or forage crop; at least one suction device for collecting the second product stream; an atomizer for converting the second product stream into droplets that can be applied to the surface of the first product stream; a drying chamber; and a circulation system for moving a drying medium through the drying chamber.

### RELATED APPLICATIONS

Benefit of priority is claimed to U.S. Provisional Application No. 62/416,627 to Daniel X. Wray et al., entitled “SYSTEMS AND METHODS FOR PROCESSING CEREAL GRASSES,” filed Nov. 2, 2016.

Where permitted, the subject matter of the above-referenced application is incorporated by reference in its entirety.

### FIELD

The present invention relates generally to systems and methods for drying a moist agricultural product, particularly forage crops and cereal grasses (e.g., alfalfa, barley, clover, rye grass, Timothy grass, oats, wheat, buckwheat, maize, millet, rice and sorghum), straw and fodder, including the stalks, stems, grains and leaves of a cereal grass.

### BACKGROUND

For forage crops to be stored and shipped, they typically must be dried to reduce their moisture content. For example, when cereal grasses or other forage crops are harvested, the standing crop material is cut and deposited on the stubble on the ground in a windrow or swath. Drying typically is done in the field by natural means by exposure to the sun and wind, allowing natural evaporation to remove the desired amount of water. The field drying process can be aided by mechanical conditioning or crimping of the forage crop. In these processes, thicker stems, shoots and stalks can be crushed, cracked or shredded to expose more surface area. After cutting and mechanical conditioning, the processed crop is left in the field to dry in windrows or placed in a swath, depending on the weather conditions. After drying, the crop is then raked and baled.

An exemplary forage crop is alfalfa. Alfalfa production is typically done in several stages, which complete a single 32 to 46 day harvest cycle. Production cycles are repeated 3 to 8 times per growing season to achieve multiple harvests and produce the total annual product yield. Climate and weather variance over the geographical range of alfalfa production can affect the total length of the growing season and the time required to complete each stage of the cultivation process. The typical durations of each stage within one production cycle are growing (25 to 30 days) and harvest (8 to 16 days), which includes cutting (1 day); tedding (1 day); drying (4 to 12 days); raking (1 day); and bailing and storage (1 day). Any unexpected precipitation during harvest could result in severe degradation in crop quality at best, and total loss of the harvest at worst. Planning harvests around weather is the primary consideration when scheduling harvests, and many modeling methods have been developed (e.g., see U.S. Pat. Nos. 9,076,118 (Mewes et al, 2015); 9,037,521 (Mewes et al, 2015); and 9,087,312 (Mewes et al, 2015)). Removing the need for natural evaporative drying would allow the crop to be cut and bailed at the optimal time, regardless of weather, and provide a more predictable and less risky harvest.

Dependence on natural field drying to reduce moisture in the crop also can limit the geographic growing range of the cereal grass or forage crop. For example, the traditional geographical production range of alfalfa is limited by the use of natural evaporation for the drying process. The need for dry climates with reasonably predictable weather precludes the use of many otherwise grow-friendly environments like the southern United States and many regions of China. Additionally, the climate limitations prevent crop production, such as alfalfa, from taking place near consumers, and this increases transportation costs. Drying enhancement techniques such as conditioning, tedding, and chemical treatment are frequently implemented to reduce drying times but are often cost-prohibitive. Further, they do not change the fact that natural drying requires solar radiation, low atmospheric humidity, and periods of no precipitation during the field drying process. This limits the geographical growing range to relatively dry climates.

All of the stages of natural field drying take place on the growing field, meaning one stage of the growing cycle cannot happen concurrently with another stage. Because the profitability of farming is directly dependent on the quantity of crop harvested, it stands to reason that maximizing the amount of field time spent on growing would result in a higher yield per season and more profit for the same land area.

The practice of drying cut forage crops in the field prior to storage can result in the production of very low quality hay. Such a procedure can subject the crops to uncontrolled weather conditions, such as rain and variable temperatures. Rain falling on a cut crop can leach out soluble nutrients and, in extreme cases, can lead to mildew or rotting. Excessive exposure to sunlight also can result in modification or destruction of some of the nutrients in the crop.

Attempts have been made in the past to design and construct an apparatus for drying forage crops after harvesting to eliminate the problems caused by field drying under natural conditions. For example, the following patents disclose various apparatus for use as transportable crop dryers: U.S. Pat. Nos. 2,602,728 (Erfurth, 1952); 2,756,554 (Diehl et al., 1956); 2,806,337 (Rezabek, 1957); 3,257,785 (Rimes, 1966); 3,512,765 (Van der Lely, 1970); 3,965,696 (Thomason, 1976); 4,644,666 (Eberle et al., 1987); 4,912,914 (Wingard, 1990); 5,060,459 (Herron, 1991); 5,105,563 (Fingerson et al., 1992); 5,557,859 (Baron, 1996); 6,032,384 (Fingerson et al., 2000); 6,223,454 (Fingerson et al., 2001); 6,598,313 (Beltrame, 2003); and 7,024,799 (Perret, 2006); and U.S. Pat. App. Pub. No. 2014/0007451 (Brown, Jr. (2014).

The various forage crop dryer devices disclosed in the above-noted patents and patent application, as well as other crop harvester devices with similar crop dryer features, have not generally been well received by the agricultural community. While the general idea of providing an apparatus for drying forage crops in the field without the need to rely on the sun and wind has been known for some time, as evidenced by the patents cited above, apparently no apparatus has been commercially successful up to this point. It is believed that the reason for the lack of success with the previous devices is that the devices have not proven very practical in operation.

For example, one of the problems with previous hay drying devices is that the high moisture content of the forage crop or cereal grass makes it difficult to dry quickly and economically without negatively impacting on the nutritional value of the dried product. Another problem with prior art hay drying devices is that they generally provide no mechanism for controlling the flow of drying air through the layer of agricultural product. Many previous devices merely direct the product through a chamber with heated air. Regions of the layer of agricultural product on a conveyor belt moving through such chambers may receive little or no air flow. In addition, regions of the layer of agricultural product that may happen to be more tightly packed than other regions similarly are deprived of any flow of drying air. The result is a layer of agricultural product with very uneven drying throughout. Those regions of agricultural product, such as cereal grass to be dried to form hay, retaining a high moisture content, are subject to deterioration, and can be subject to attack by mold or bacteria. Other devices rely on solar energy to provide the heat to warm and dry the air in the chamber. Such reliance on the sun subjects the device to the vagaries of weather, since the device is inoperable or operable at lower efficiency on cloud-covered days.

It is clear that there is a significant need for more efficient and effective drying devices for drying harvested crops.

### SUMMARY

The present invention can solve these and other problems which exist with existing harvesting techniques and drying devices to improve the quality of the crop harvest, and does so in a manner which is believed to be commercially practicable.

It is an object of this invention to provide a drying system that substantially reduces the drying time of cereal grasses and other forage crops. Because the drying system is not dependent on sun or wind, the system is not subject to the vagaries of weather.

Another object of the present invention is to provide new and improved systems for drying cereal grasses. The systems can be economical to manufacture using existing technology and components. The systems can be energy efficient, highly reliable in operation, not readily subject to breakdown and malfunction, and can require a minimum of maintenance and servicing. The numerous advantages and resulting savings in cost and time from this invention are easily recognized by those of ordinary skill in the art.

The systems and methods provided herein can result in the elimination of currently required farm equipment. For example, the drying system provided herein does not require that the agricultural product be tedded and raked in order to dry. Accordingly, the drying device and methods provided herein can eliminate the need for the tedding and raking processes that are currently used in forage crop harvesting. Eliminating these processes eliminates the need for the machines used to carry them out, further increasing the economic benefit of the systems and methods provided herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the problems or deficiencies discussed herein.

Provided are systems for drying a cereal grass or forage crop, the system including a conditioner; a first pressing roll and a second pressing roll that form a nip therebetween through which the cereal grass or forage crop can be pressed, pressing the liquid out of the cereal grass or forage crop to form a first product stream comprising a dewatered cereal grass or forage crop and a second product stream comprising liquid pressed out of the cereal grass or forage crop; at least one suction device for collecting the second product stream; a drying chamber; a perforated conveyor for moving the cereal grass or forage crop through the drying chamber; and a circulation system for moving a drying medium through the drying chamber.

The conditioner can include a set of grooved or ribbed rollers that interact to crimp or to crush or to crimp and crush the cereal grass or forage crop. The conditioner can include a plurality of equally circumferentially spaced ribs extending across the axial length of the roll, the ribs having a slope relative to the axis of the roll reversing from positive to negative at least once. The conditioner can include ribs and the ribs can be positioned to form a sinusoidal configuration. The conditioner can include a first roll and a second roll having ribs and grooves of a similar configuration reversed end for end, the ribs of the first roll intermeshing with the grooves of the second roll.

The drying systems provided herein can include a chemical applicator for applying a chemical solution to the cereal grass or forage crop prior to the cereal grass or forage crop entering the conditioner. The chemical applicator can include an atomizing spray nozzle; a metering pump for supplying a chemical solution to the spray nozzle; and an electrical control for actuating the metering pump to provide a supply of chemical solution to the spray nozzle.

The drying systems can include a pre-treatment roller unit, which includes a first covered roll and a second covered roll that form a nip through which the cereal grass or forage crop can be passed to remove surface moisture, the first covered roll having a first covering and the second covered roll having a second covering. The pre-treatment roller unit can include a first suction device to remove liquid from the first covering and a second suction device to remove liquid from the second covering. The first suction device or second suction device or both can extend in a direction parallel to the axis of the roll with which it is associated and sealingly engages an outer surface of the roll to form a delimited suction zone. At least one of the first pressing roll or the second pressing roll can be a perforated roll shell. When one of the pressing rolls is a perforated roll shell, a suction device can be positioned inside of the perforated roll shell to collect the second product stream. When present, the suction device inside of the perforated roll shell can extend in a direction parallel to the axis of the perforated roll shell and is positioned such that it sealingly engages an inner surface of the perforated roll shell such that a delimited suction zone is formed. The drying systems provided herein can include a pump for pumping the collected second product stream to a container.

The drying systems provided herein can include a drying chamber enclosed in a cabinet. The cabinet can include an inlet for receiving the first product stream and an outlet for discharging a dewatered cereal grass or forage crop. The cabinet can be constructed from a material selected from among wood, plastic, fiberglass composite, metal or a combination thereof. The drying systems can include a variable speed electric motor and drive unit for moving the conveyor. The drying systems can include a diverter on the underside of the perforated conveyors that captures any material that might pass through the perforations of the conveyor. The drying systems can include a drying medium intake aperture and a drying medium exhaust aperture. The drying systems can include a circulation system that includes a blower unit.

The drying systems can include a drying chamber that includes or is connected to a treatment cycle for reconditioning the drying medium. The treatment cycle can include a heat exchanger, a heating device, a compressor, a desiccant chamber or any combination thereof.

In some configurations, the drying system can include multiple chambers. It should be recognized that although some configurations are described as containing multiple chambers, those activities performed in separate chambers of a multi-chamber system can be performed in a single chamber. In configurations containing more than one chamber, a second drying chamber can be included, the chamber comprising an inlet for accepting the dried second product stream from the first chamber. The second drying chamber can include an atomizer for atomizing the second product stream into droplets that pass through a drying medium and are deposited on the first product stream within the second drying chamber. A perforated conveyor within the second drying chamber can move the first product stream through the second drying chamber. A variable speed electric motor and drive unit can be used to move the conveyor in and through the second drying chamber.

The second drying chamber of the drying system can include a drying medium intake aperture and a drying medium exhaust aperture. The second drying chamber can include a blower unit. The second drying chamber can include a second treatment cycle for reconditioning the drying medium. The second treatment cycle can include a heat exchanger, a heating device, a compressor, a desiccant chamber or any combination thereof.

The drying system provided herein can include a mechanical mixer positioned above at least one portion of the conveyor. The mechanical mixer can redistribute the cereal grass or forage crop on the conveyor as it passes through the chamber(s). The mechanical mixer can include a rotating wheel with protections that can engage with the cereal grass or forage crop on the conveyor, picking up at least a portion of the cereal grass or forage crop from the conveyor and flipping it over by bringing it up and over the rotating wheel in a circular motion. The projections can be positioned completely around the circumference of the wheel, or around only a portion of the circumference of the rotating wheel to allow some material to pass under the wheel without engaging with the projections and being picked up by the projections on the rotating wheel.

The drying system provided herein can include a scale to measure the weight of the cereal grass or forage crop deposited into the drying chamber. The drying system provided herein can include a cleaning system that includes sprayers that can apply a cleaning solution to surfaces within the chamber of the system. The sprayers of the cleaning system can include a pressurizing system to increase the force with which the cleaning solution is applied within the chambers of the system. The pressurizing system can include pumps or compressed gas or a combination thereof to increase the force of the fluid ejected by the sprayers. The cleaning system can include a draining system for removing the cleaning solution from the drying system.

The drying systems provided herein can include an obstruction sensor to detect if any material becomes adhered to a roll. The obstruction sensor can include a pair of optical sensors mounted to project a beam of light of any wavelength across length of roller, that when interrupted by material adhered to the roller, will interfere with the transmission of the light beam of the optical sensor, indicating material is adhered to the surface of a roller. The drying systems provided herein can include a blade or brush to remove any material that becomes adhered to the roll. The drying systems provided herein can include a jet spray that can direct a high pressure air stream or water stream onto the surface of the rollers. The jet spray can be configured to have a force sufficient to dislodge any cereal grass or forage crop that becomes adhered to a roller, or to have a force sufficient to cut through any cereal grass or forage crop that adheres to a roller. The obstruction sensor can be in communication with the blade or brush or the jet spray or any combination thereof to clear any obstruction from a roll surface.

The drying systems provided herein can include a gap adjuster that can adjust the size of the nip between the first pressing roll and the second pressing roll. The gap adjuster can be in communication with a sensor measuring the rate of rotation of the pressing rolls. A decrease or stop of rotation due to an accumulation of material between the rollers signals the gap adjuster to momentarily increase the gap between the rollers to allow any clumped material to pass. The gap adjuster can be in communication with the obstruction sensor, blade, brush or jet spray or a combination thereof. The drying systems provided herein can include a temperature sensor or a humidity sensor or both within the chamber.

The drying systems provided herein can include a computer for partial or complete automation of the system. The computer can be in communication with, or in control of, or in communication with and in control of a) the pre-treatment rollers; b) the conditioner; c) the pressing rollers; d) the vacuum systems; e) any heating device(s); f) the fan(s) or blower(s) of the drying chamber(s); g) the pumps of the sprayers; h) the conveyors; i) the heat exchanger(s); j) the air compressor(s); k) the temperature sensor; l) the humidity sensor; or any combination of a) through l). The computer can include a non-transitory computer-readable storage medium having a computer-readable program embodied therein for directing operation of the drying system and/or any component of the drying system. The program can adjust the nip width and pressure according to an input description of the type of crop being processed. The computer can control the flow and speed of the drying medium throughout the chamber(s). The computer can be in communication with temperature and/or humidity sensors within the chamber, and can adjust the flow of drying medium within the chamber in accord with predetermined temperature and humidity parameters. The computer can be programmed to be self- optimizing based on the sensors within the chamber and can adjust the temperature, speed and volume flow of drying medium through the chamber to optimize drying and efficiency of the system. The computer can include a program that provides a selectable operational mode that allows selection of a type of crop to be processed, and the computer can adjust the components of the system to dry the type of crop designated.

Also provided are methods of drying a cut cereal grass or forage crop. The methods include passing the cereal grass or forage crop through a pressing nip formed between a first pressing roll and a second pressing roll such that liquid in the cereal grass or other forage crop is pressed out of the cereal grass or other forage crop when the cereal grass or other forage crop passes through the first nip to form a first product stream comprising dewatered cereal grass or dewatered forage crop and a second product stream comprising the liquid pressed out of the cereal grass or forage crop; subjecting the first product stream to a drying medium to reduce the moisture content of the first product stream to produce a dried first product stream; atomizing the second product stream into droplets using an atomizer and passing the droplets through a drying medium over the first product stream to yield a coated first product stream; and subjecting the coated first product stream to a drying medium to reduce the moisture content of the coated first product stream to a targeted moisture content to yield a dried product. The second product stream can be collected by aspiration using a suction device and transferred to a container. The second product stream can be provided to the atomizer using a pump.

The methods can include as a step mixing an additive into the second product stream prior to atomization. The additive can be selected from among a corn steep liquor, a barley extract, a yeast extract, waste from beer fermentation broth (WBFB), molasses, an enzyme, an ionophore, a probiotic, sodium bicarbonate, sodium sesquicarbonate, zinc methionine, a vitamin, an oil, a fatty acid, a fat, a mineral, an amino acid, a phospholipid, an anti-oxidant, an agent to prevent biological contamination and combinations thereof. The enzyme can be a phytase or a glycanase. The ionophore can be monensin sodium (Rumensin®) or lasalocid sodium (Bovatec®). The probiotic can be a strain of bacteria selected from among Bifidobacterium, Enterococcus, Bacillus, and Lactobacillus. The fatty acid can include alpha-linolenic acid (ALA), eicosa-pentaenoic acid (EPA), or docosahexaenoic acid (DHA). The anti-oxidant can include Vitamin E, a tocopherol, mixed tocopherols, a carotenoid, a polyphenolic compound, ascorbic acid, eugenol, thymol, green tea extract, rosemary oil or extract, thyme white oil or combinations thereof. The agent to prevent biological contamination can be acetic acid, ascorbic acid, benzoic acid, citric acid, phosphoric acid, propionic acid, sorbic acid, and salts and combinations thereof.

In the methods provided herein, the moisture content of the first product stream after passing through the pressing nip formed between the first pressing roll and the second pressing roll can be in the range of from about 25 to about 30% by weight. The moisture content of the coated first product stream, produced after application of the second product stream onto the first product stream and passing through a drying chamber, can be in a range from about 16% to about 22% by weight. The linear load applied at the pressing nip can be in the range of about 1 kN/m to about 4,000 kN/m. In some methods, at least one of the first pressing roll and the second pressing roll is a perforated roll shell. When a pressing roll is a perforated roll shell, the second product stream can be sucked through the perforated roll shell by a suction device located inside of the perforated shell roll. The suction device can extend in a direction parallel to the axis of the perforated roll shell and sealingly engages an inner surface of the perforated roll shell such that a suction zone is formed in the area between suction device and the inner surface of the perforated roll shell. The suction device is operated during pressing and creates a reduced pressure in the suction zone. The suction zone can extend to both sides of the first nip.

The methods provided herein can include as a step passing the cereal grass or forage crop through a conditioner prior to passing through the pressing nip. The conditioner can include a set of grooved or ribbed rollers that interact to crimp or to crush or to crimp and crush the cereal grass or forage crop. The conditioner can include a plurality of equally circumferentially spaced ribs extending across the axial length of the roll, the ribs having a slope relative to the axis of the roll reversing from positive to negative at least once. The conditioner can include ribs and the ribs can be positioned to form a sinusoidal configuration. The conditioner can include a first roll and a second roll having ribs and grooves of a similar configuration reversed end for end, the ribs of the first roll intermeshing with the grooves of the second roll. The methods can include as a step treating the cereal grass or forage crop with a chemical solution prior to entering the conditioner. The chemical solution can include a chemical that disrupts the cuticle of the cereal grass or forage crop. The chemical solution can include a desiccant. The desiccant can be selected from among potassium carbonate, sodium carbonate, sodium hydroxide and combinations thereof. The chemical solution can be an aqueous solution of a desiccant. The desiccant can be present in an amount of from about 1 wt % to about 5 wt % based on the total weight of the composition. The chemical solution can be applied in an amount to deliver an amount of desiccant from about 5 pounds to about 20 pounds per ton of cereal grass or forage crop. The chemical solution can include a C₁-C₅ alcohol. The methods provided herein can include as a step, after passing the cereal grass or forage crop through the pressing nip, treating the cereal grass or forage crop with hydrogen peroxide, an acid, a protease, a carbohydrase, a preservative, or a combination thereof.

The methods provided herein can include as a step passing the cut cereal grass or forage crop through a pre-treatment nip formed by a first covered roll and a second covered roll to remove surface moisture from the cereal grass or forage crop. The covered rolls can include a covering that can absorb moisture. The covered rolls can include a covering that is compressible and can conform to the shape of the cereal grass or forage crop passing through the second nip. The covered rolls include a covering that is resilient and returns to its original shape after the cereal grass or forage crop has passed through the nip.

The methods provided herein can include as a step spraying the dried product with a preservative prior to baling. The preservative can include acetic acid or propionic acid or combinations thereof. The methods provided herein can be performed as a batch process. The methods provided herein can be performed as a continuous process.

Other objects, features and advantages of the systems and methods described herein will become apparent to those skilled in the art from the following detailed description. It is to be understood, however, that the detailed description, while indicating certain embodiments of the systems and methods described herein, are given by way of illustration and not limitation. Many changes and modifications within the scope of the present invention may be made without departing from the spirit thereof

While certain aspects of conventional technologies have been discussed to facilitate disclosure of the invention, it is contemplated that the claimed invention may encompass one or more of the conventional technical aspects discussed herein.

### DETAILED DESCRIPTION

### BRIEF DESCRIPTION OF THE FIGURES

The drawings described herein are for illustrative purposes only of selected embodiments and not all possible implementations, and are not intended to limit the scope of the present disclosure.

FIG. 1 is a schematic diagram of a basic process flow of an exemplary configuration of the drying system 1000 provided herein.

FIG. 2 is a schematic depiction of an exemplary configuration of the pre-treatment rollers 50.

FIG. 3 is a schematic depiction of an exemplary configuration of the chemical applicator 75.

FIGS. 4A and 4B are schematic depictions of exemplary configurations of the conditioner unit 100.

FIGS. 5A-5D are schematic depictions of exemplary configurations of a second set of rolls. FIG. 5A shows a set of two imperforate rolls. FIGS. 5B and 5C show a set of rolls in which one roll is an imperforate roll and the other is a perforated roll shell. FIG. 5D shows a set of rolls that includes two perforated roll shells.

FIG. 6A is a schematic depiction of an exemplary configuration of a first drying chamber 300 and its associated drying medium treatment cycle.

FIG. 6B is a schematic depiction of an exemplary configuration of a conveyor that includes mechanical mixer devices above the conveyor.

FIG. 7 is a schematic diagram of a basic process flow of an exemplary configuration of the treatment cycle 400.

FIG. 8 is a schematic drawing of an exemplary spiral conveyor system.

FIG. 9 is a schematic depiction of an exemplary configuration of a second drying chamber 500 and its associated drying medium treatment cycle.

FIG. 10 is a schematic diagram of a basic process flow of an exemplary configuration of the treatment cycle 600.

FIG. 11 is a schematic depiction of an exemplary configuration of an optional third drying chamber 800 and its associated drying medium treatment cycle.

FIG. 12 is a schematic diagram of a basic process flow of an exemplary configuration of the treatment cycle 900.

Corresponding reference numerals indicate corresponding parts throughout the several views of the drawings. For parts which are similar but not the same as parts originally specified with a given number, a prime (′) of the original number(s) is used.

The drawings in the present application and their accompanying detailed description are directed to merely exemplary implementations. The drawings are generally not to scale, some of the dimensions are for the clarity of presentation and are shown exaggerated in the drawings, and are not intended to correspond to actual relative dimensions. Certain elements in some of the figures may be omitted, or illustrated not to scale, for illustrative clarity. The cross-sectional views may be in the form of “slices”, or “near-sighted” cross-sectional views, omitting certain background lines which would otherwise be visible in a “true” cross-sectional view, for illustrative clarity. Further, only those elements which are useful to the understanding of the present invention have been shown and described. Although the views in the drawings for ease of description generally show similar orientations, this depiction in the drawings is arbitrary for the most part and the device or system could be illustrated and operated in any orientation.

### A. Definitions

Unless defined otherwise, all technical and scientific terms used herein have the same meaning as is commonly understood by one of skill in the art to which the inventions belong.

All patents, patent applications, published applications and publications, websites and other published materials referred to throughout the entire disclosure herein, unless noted otherwise, are incorporated by reference in their entirety. In the event that there are a plurality of definitions for terms herein, those in this section prevail.

As used here, the singular forms “a,” “an” and “the” include plural referents unless the context clearly dictates otherwise.

As used herein, ranges and amounts can be expressed as “about” a particular value or range. “About” also includes the exact amount. Hence “about 5 percent” means “about 5 percent” and also “5 percent.” “About” means within typical experimental error for the application or purpose intended.

As used herein, “optional” or “optionally” means that the subsequently described element, event or circumstance does or does not occur, and that the description includes instances where the element, event or circumstance occurs and instances where it does not. For example, an optional component in a system means that the component may be present or may not be present in the system.

In the examples, and throughout this disclosure, all parts and percentages are by weight (wt %) and all temperatures are in ° C., unless otherwise indicated.

As used herein, the phrase “based on the weight of the composition” with reference to % refers to wt % (mass % or (w/w) %).

As used herein, “thermal energy” refers to power that produces heat.

As used herein, an “essentially closed system” with respect to the circulating air means that the pathway of air in the system has minimal to no interaction with the environment external to the air pathway, but does not preclude some air loss to the environment.

As used herein, “cereal grass” refers to any agricultural product cultivated for use as a food or feed for animals, and includes cereals and legumes, including alfalfa, barley, Bird's-foot trefoil, clover, cow pea, rye grass, orchard grass, Timothy grass, oats, wheat, buckwheat, maize, millet, rice and sorghum.

As used herein, “hay” refers to a cereal grass or forage crop that has been dried for use as feed for animals.

As used herein, a “forage crop” refers to any annual or biennial crop grown to be used for feed for animals.

As used herein, “perforation diameter” when used in the context of the size of a perforation with a non-circular shape (e.g., an elliptical, rectangular or triangular shape), means that the area of the perforation through which water and/or air can flow equals or is substantially the same as the area of a circular perforation with this diameter.

As used herein, “imperforate” means not perforated, and an “imperforate surface” refers to a solid surface having no perforations.

As used herein, “cfm” means cubic feet per minute.

As used herein, “tonne” refers to a metric ton, which is 1,000 kg.

As used herein, a “conditioner” refers to a set of grooved or ribbed rollers that interact to crimp or crush or crimp and crush a cereal grass or a forage crop to produce more surface area and promote faster drying.

As used herein, a “rib” of a conditioner roll refers to the raised portion of roll that interacts with a raised portion of another roll to crush or crimp material passing therebetween. A groove is formed between two ribs.

### B. DRYING SYSTEMS

Provided herein are systems that can greatly reduce or eliminate the problems common in prior art hay drying devices. Prior art hay drying devices and methods require large amounts of energy which makes such methods and systems less effective in terms of energy economy. The present systems and methods can be more economical in terms of energy economy because the cereal grass or forage crop is substantially dewatered prior to drying. In the systems and methods provided herein, the freshly cut cereal grass (reference to which includes all forage crops) can be passed through a first set of covered rolls to remove any surface water, such as from dew or other condensation or from rain or irrigation. The cereal grass can pass through the first set of rolls to a second set of rolls, which use compression to force out liquid within the cereal grass, producing a first product stream of dewatered cereal grass and a second product stream of expressed grass liquid. The expressed grass liquid from the cereal grass includes water and can include nutrients, such as carbohydrates, minerals, vitamins and proteins. The roller compression can remove liquid from the cereal grass with low energy consumption. Although described using rolls to extract the liquid, the system can be modified to use a hydraulic press, a screw press or a belt press to express the liquid from the cereal grass or forage crop.

The first product stream containing the dewatered cereal grass then is directed to a cabinet enclosing and defining a drying chamber having a product inlet and a product outlet. The dewatered cereal grass passes through the drying chamber, e.g., via a conveyor belt, during which the second product stream containing the expressed grass liquid can be applied to the dewatered cereal grass to restore any nutrients extracted during the pressing process. Moisture from the applied grass liquid evaporates in the drying chamber, and a dry coated cereal grass product is produced, exiting the drying chamber. The dry coated cereal grass product can be baled by a conventional baler. Throughout this disclosure, reference to a cereal grass includes any forage crop.

Pre-treatment Rolls

The drying systems provided herein can include a set of pre-treatment rolls, between which the cut cereal grass can pass. The pre-treatment rolls contain at least two rolls that form a nip through which the cereal grass can pass. The rolls include a covering that can wick and absorb water from the cereal grass. Examples of such covering materials include a wettable fabric such as felt, fiberglass fabric, bamboo/hemp fleece, chamois cloth, polyurethane foam, and combinations thereof. The fabric can have a pattern of protrusions or depressions of between 0.1 to 2.5 mm in depth in order to promote water wicking. The fabric can include a microporous or microperforated film. The fabric can include a nonwoven or spun-bonded sheet material. The nonwoven or spun-bonded sheet material can be calendered to stabilize the fibers of the fabric. The fabric is compressible and can conform to the shape of the cereal grass passing through the nip to absorb surface moisture, and is resilient in that it substantially returns to its original shape after the cereal grass has passed through the nip.

The pre-treatment rolls also include dewatering rolls that are in contact with and compress the covered rolls to press the absorbed moisture from the rolls. The dewatering rolls are of a hard material, such as steel, stainless steel or non-compressible rubber or other polymer. Each of the dewatering rolls includes an assembly that includes at least one suction device for aspirating the water removed from the covered rolls by the compression of the dewatering roll and removing the aspirated water for disposal. The suction device(s) is/are arranged to collect the water pressed out of the covered rolls, such as at the nip formed between the dewatering roll and the covered roll. The at least one suction device can extend in a direction parallel to the axis of the covered roll and can be positioned such that it sealingly engages an outer surface of the covered roll such that, a delimited suction zone is formed in the area between the at least one suction device, the outer surface of the covered roll and the dewatering roll. In the delimited suction zone, water that has been pressed out of the fabric-covered roll can be aspirated and removed. Another set of suction devices can be located on the other side of the nip produced between the covered roll and the dewatering roll to further remove moisture from the covered roll before it is brought into contact with more cereal grass.

The covered rolls can be contained in a roll stand. Actuators, e.g., hydraulic, pneumatic, mechanical or electronic actuators, can be suitably arranged to bring the rolls together to form the nip between the rolls so that the cereal grass that passes through the nip will be pressed into the compressible fabric covering the rolls so that surface moisture on the cereal grass can be absorbed and wicked away by the covering. One of the rolls or both of the rolls can be provided with a drive for driving the roll(s).

Chemical Applicator

The drying systems and provided herein can include an applicator for applying a chemical solution onto the cut cereal grass prior to the cereal grass being conditioned in a conditioner unit. The chemical applicator can include an atomizing spray nozzle, a metering pump for supplying the chemical solution to the spray nozzle, and an electrical control for actuating the metering pump to provide a supply of chemical solution to the spray nozzle as desired. Any spray nozzle or spraying configuration known in the art can be adapted for use with the chemical applicator. Exemplary sprayers are described in U.S. Pat. Nos. 4,344,573 (De Felice, 1982); 4,650,124 (Connaughty et al., 1987); 4,662,163 (Adams, 1985); 5,680,993 (McCracken et al., 1997); 6,622,935 (Owens et al., 2003); and 6,848,627 (Oepping et al., 2005). The chemical applicator can include a tank for storing the chemical solution.

The nozzles of the chemical applicator can be of any type, including flood spraying, stream spraying, and mist spraying types. In some configurations, the chemical applicator includes a set of nozzles facing each other with a space therebetween to allow the cereal grass to pass. As the cereal grass exits the pre-treatment rollers, it can pass through the space between the nozzles. The cereal grass can be subjected to the spraying of the chemical solution from the nozzles, which covers the outward facing surfaces of the cereal grass, and also enters the openings between the cereal grasses. A plurality of nozzles can be arranged so that the chemical solution exiting the nozzle covers the full width or length of the chemical applicator. Nozzles can be arranged rearwardly of the entrance of the chemical applicator to apply the chemical solution before entering the chemical applicator to increase coverage. Nozzles can be arranged forwardly of the exit of the chemical applicator to apply chemical solution to the cereal grass after it exits the chemical applicator and prior to entering the conditioner unit. The amount of chemical solution applied can be automatically controlled by a computer, or can be increased or decreased manually by the operator adjusting the controller, which can modulate the pump speed to apply more or less chemical solution. Controls for controlling pump speed or power provided to the pump in order to adjust its speed and the amount of chemical solution provided to the nozzles are known in the art.

The application of the chemical solution to the cut cereal grass prior to entry of the cut cereal grass into the conditioner unit of the drying system provided herein can quicken drying rates. The chemical solution can be used to disrupt the waxy cuticle in order to accelerate drying. The chemical solution can include a desiccant. The chemical solution can be an aqueous solutions of a desiccant. Examples of desiccants include potassium carbonate, sodium carbonate, sodium hydroxide and combinations thereof. The chemical solution can include a desiccant present in an amount of from about 1 wt % to about 5 wt % based on the total weight of the composition. The chemical solution can include an alcohol, such as a C₁-C₅ alcohol. The amount of solution applied can vary. The chemical solution can be applied in an amount to saturate the cereal grass. When the chemical solution includes a desiccant, the amount of solution applied is calculated to deliver an amount of desiccant from about 5 pounds to about 20 pounds per ton of cereal grass.

Conditioner Unit

The drying system can include a conditioner unit, which contains a conditioner. Devices referred to as conditioners are generally utilized to facilitate the faster drying of the crop by crimping, crushing and/or fracturing the stem of the agricultural product to facilitate removal of the moisture in the product. Conditioners typically include two or more elongated parallel rollers, slightly spaced apart from one another. The respective adjacent rollers rotate in opposite directions from one another. Agricultural product is fed through the gap between the two rollers. The rollers are typically made of steel, but with a rubber, elastomer or other compressible surface or coating around the circumference. The roller surface typically has raised intermeshing portions to further the gripping or crimping of the crop. Other conditioners use impact style rotors with outwardly extending projections to further assist in the crimping of the crop.

Typically, the conditioner includes upper and lower, transverse conditioner rolls through which the cut cereal grass passes. Typically, the upper roll is mounted for movement toward and away from the lower roll and is biased downwardly for upward bodily movement in response to crops passing between the rolls. A predetermined clearance generally is maintained between the surfaces of the rolls, the amount of clearance depending in large part upon the nature of the crops being conditioned. For most conditions, a minimum clearance is desired to achieve maximum conditioning of alfalfa and other high value crops. Other crops can require a differently spaced gap for appropriate feed through and conditioning. The conditioner unit is configured so that the rolls do not operate in continuous contact with each other.

The rolls can be configured to have surfaces that mesh during revolution of the rolls. The surface configurations of these rolls are used to effect crimping of the stock of the cereal grass, and to mechanically abrade or disrupt surface cuticle layers, the mechanical disruption creating cracks and passage ways for water to evaporate during drying. Some configurations include cooperative pneumatic tired wheels as the conditioner rolls. Some configurations include a plurality of equally circumferentially spaced ribs extending across the axial length of the roll, the ribs having a slope relative to the axis of the roll reversing from positive to negative at least once. The ribs can be configured so that the absolute value of the slope gradually decreases to zero, and then gradually increases upon approaching and passing the point of reversal. The rib configuration can be sinusoidal. A roll can be configured to run on a parallelly disposed roll of similar configuration reversed end for end, the ribs of one roll intermeshing with the grooves of the adjacent roll.

The rolls can be separately driven in timed relation to each other by a gear train or motor system as is well known. The rolls do not depend upon meshing to cause them to rotate. The rolls can include mounting and adjustment mechanisms to adjust the gap between the rollers. The separate drive units can minimize any damage that could be caused in part, from the fact that intermeshing rolls driven at the same rotational speed have different surface speeds at the points of intermeshing engagement causing scuffing of the rolls, and noise and torsional vibration in the drive train.

There are numerous prior patents that fully describe the use of cooperative rollers to effect conditioning of crops. See U.S. Pat. Nos. 3,128,586 (Johnston, 1964); 3,431,710 (Johnston, 1969); 3,513,645 (Garrett et al., 1970); 3,890,770 (Milliken, 1975); 4,177,625 (Knight et al., 1979); 4,395,866 (Mathews, 1983); 4,075,822 (Heckley et al, 1978); 4,472,927 (Vogt, 1984); 4,850,183 (Fox, 1989); 5,396,755 (Arnold, 1995); 5,443,421 (Heintzman, 1995); and 6,711,996 (Mackie, 2004). The maceration of the cereal grass can improve dewatering.

Pressing Rolls

The systems provided herein include pressing rolls. After passing through the conditioner, the cereal grass is fed into the pressing rolls. The pressing rolls include at least two rolls that form a nip through which the cereal grass is pressed. The pressing rolls are of a hard material, such as steel, stainless steel or a non-compressible rubber or polymer. Each of the pressing rolls includes an assembly that includes at least one suction device for aspirating the expressed grass liquid pressed from the cereal grass by the compression of the cereal grass in the nip between the pressing rolls. The expressed grass liquid is collected via conventional techniques, such as by suction by applying a reduced pressure or vacuum device along the length of the one or both of the pressing rolls to aspirate the liquid expressed from the cereal grass and transfer the expressed grass liquid to a holding container. The at least one suction device can extend in a direction parallel to the axis of the pressing roll and can be positioned such that it sealingly engages an outer surface of the pressing roll such that, a delimited suction zone is formed in the area between the at least one suction device and the press roll. In the delimited suction zone, expressed grass liquid that has been pressed out of the cereal grass due to the compressive forces of the pressing rolls can be sucked up and transferred to a holding container. Transfer can occur via gravity or by the use of a pump. In some configurations, the suction device sealingly engages the outer surface of the pressing roll by means of a first seal that extends in the axial direction of the pressing roll (which is also the axial direction of the suction device).

Alternatively, one or both of the pressing rolls can be perforated, allowing the expressed juices from the cereal grass to pass into the interior of the roll(s) and be collected, such as by use of a suction device, an aspiration funnel or low pressure trough inside the roller. In this configuration, the pressing rolls can be tubes or roll shells instead of solid cylinders, and include perforations in the roll shell, with the roll shell having a sufficient thickness to be able to exert the compression forces needed to extract the liquid from the cereal grass. In some configurations, the pressing rolls includes a roll that has no perforations and a roll that contains perforations. At least one suction device can be positioned within the perforated roll to collect the expressed grass liquid. The at least one suction device can extend in a direction parallel to the axis of the pressing roll and can be positioned such that it sealingly engages an inner surface of the pressing roll such that, a delimited suction zone is formed in the area between the at least one suction device and the pressing roll. In the delimited suction zone, expressed grass liquid that has been pressed out of the cereal grass due to the compressive forces of the pressing rolls can be collected via aspiration and transferred to a holding container. Transfer can occur via gravity or by the use of a pump. In some configurations, the suction device sealingly engages the inner surface of the pressing roll by means of a first seal that extends in the axial direction of the pressing roll.

At least one suction device can be located inside a pressing roll or pressing role shell. The suction device can be arranged to collect via suction through the pressing roll the liquid pressed out of the cereal grass. The suction device can include an axially extending seal that engages an inner surface of the pressing roll or pressing roll shell such that the suction device sealingly engages the pressing role or pressing role shell. The axially extending seal can be substantially parallel with the axis of the roll or role shell and can be arranged to seal against the pressing role or pressing role shell. The axially extending seal can be made of different materials. The axially extending seal can include an elastic polymer. For example, the axially extending seal can be, wholly or in part, made of rubber, polyacrylate rubber, inert silicone elastomer (Silastic), polysiloxane, fluorosilicone, chlorosulfonated polyethylene, polyisoprene, neoprene, fluoropolymer elastomer (Viton) and combinations thereof.

The suction device can extend in a direction parallel to the axis of the pressing roll or pressing role shell. The suction device can have an axial length that is substantially as long as the axial length of the pressing role or pressing roll shell. When the suction device extends for at least the entire axial length of the pressing roll or pressing roll shell, the suction can operate over the entire axial length of the nip or the second set of rolls. Liquid that has been pressed out of the cereal grass is removed by the suction of the suction device.

The suction device can be positioned so that suction can be applied directly at the exit from or at the entry to the nip, depending on whether the suction device is positioned downstream of or upstream of the nip. In some configurations, a suction device can be included on each side of the nip, allowing fluid expressed from the cereal grass to be removed by suction on both sides of the nip.

When the pressing roll includes perforations, the perforations can be of any shape. Exemplary shapes include square, rectangular, circular, oval and triangular. The average perforation diameter can be in the range of from about 0.1 mm to about 5 mm. The perforations can be distributed in any pattern on the roll shell. For example, the perforations can be placed in parallel lines that spiral from one end of the roll shell to the other. The perforations can be distributed in a checkerboard pattern, with each collection of perforations creating a square, circular or triangular design. Some of the perforations can be created from the inside to the outside of the roll shell, resulting in protrusions that can grab onto the cereal grass and pull it through the nip.

The number of perforations that can be included can depend on the thickness of the roll shell, as a thicker roll shell can accommodate more perforations while maintaining sufficient physical strength to exert the necessary compression force on the cereal grass to express the liquid from the cereal grass. The perforations in the roll shell result in a collective open area in the roll shell. In some configurations, the open area can be in the range of from about 5% to about 50%. The open area can be selected depending on the cereal grass to be processed to achieve a good expression of liquid from the cereal grass while maintaining sufficient strength of the roll shell.

In configurations in which the pressing rolls include a roll shell with perforations, an air jet can be included inside the roll shell to blow a stream of air through the perforations from the inside to the outside to remove any debris and minimize any clogging of the perforations.

The pressing rolls or pressing roll shells can be contained in a roll stand. Actuators, e.g., hydraulic, pneumatic, mechanical or electronic actuators, can be suitably arranged to force the second pressing roll or pressing role shell against the first pressing roll or pressing role shell to form a nip, such that the nip can be loaded with and pass through the nip cereal grass to be dewatered by being compressed by the force in the nip. The actuators can modulate the force at the nip in order to extract the liquid from the cereal grass. One of the rolls or both rolls can be provided with a drive for driving the roll.

The pressing rolls also can include an obstruction sensor that can detect if any material becomes adhered to a roll. For example, an obstruction sensor can be positioned after the nip. The obstruction sensor can be configured to include a pair of optical sensors mounted to project a beam of light of any wavelength across length of roller, that when interrupted by material adhered to the roller, will interfere with the transmission of the light beam of the optical sensor, indicating material is adhered to the surface of a roller. The pressing rolls can include a blade or brush to remove any material that becomes adhered to the roll. The blade or brush can be positioned so that it scours the surface of the rolls after the nip, depositing any material removed from the rolls with the dewatered grass that passes through the nip. This can assure that no cereal grass material builds up on the roll and all of the cereal grass material is recovered. The pressing rolls can include a jet spray that can direct a high pressure air stream or water stream onto the surface of the rollers with sufficient force to dislodge any cereal grass that becomes adhered to a roller, or to cut through any cereal grass that adheres to a roller. The obstruction sensor can be in communication with the blade or brush or jet spray or their combination to clear any obstruction from a roll surface.

The pressing rollers can include a gap adjuster. The gap adjuster allows the size of the nip to be increased or decreased depending on the cereal crop to be dried. The gap adjuster also can serve as an anti jam device. For example, should the rotation of the rollers slow or stop due to an accumulation of material between the rollers, such as due to a large clump of material entering the nip, the gap adjuster can be activated to momentarily increase the gap between the rollers to allow any clumped material to pass. This can minimize the possibility of cereal grass wrapping about the rollers. The gap adjuster can be in communication with the obstruction sensor, blade, brush or jet spray or combinations thereof to remove any obstructions.

The amount of pressure required at the nip to effectively extract the liquid from the cereal grass will depend on the cereal grass being processed. In most applications, a linear load can be applied at the nip (formed in the second set of rolls by the pressing rolls) in the range of about 1 kN/m to about 4,000 kN/m, or 2 kN/m to about 3,000 kN/m, or 3 kN/m to about 2,000 kN/m, or 4 kN/m to about 2,000 kN/m, or 5 kN/m to about 1,000 kN/m, or 2.5 kN/m to about 500 kN/m, or 3 kN/m to about 300 kN/m, or 2 kN/m to about 200 kN/m, or 1 kN/m to about 100 kN/m. Such a force generally is sufficient for effective extraction of liquid for many of the cereal grasses. When more resilient material, such as stocks of maize, are to be processed, a force in the range of from about 200 kN/m to about 4,000 kN/m may be necessary for effective extraction of liquid. Linear loads higher than 4,000 kN/m or lower than 50 kN/m can be used for some cereal grasses or portions thereof

The pressing rollers can be run at a speed that keeps up with the drying system so that the rollers do not bottleneck the drying system. In some configurations, the throughput through the rollers is at least 5 pounds/sec, or at least 10 pounds/sec, or at least 15 pounds/sec, or at least 25 pounds/sec, or at least 50 pounds/sec, or at least 75 pounds/sec. In some configurations, the throughput through the rollers is from about 10 pounds/sec to about 100 lbs/sec. Because the drying system provides significantly faster drying than air drying, the cutting rate can be slowed while still resulting in increased productivity.

First Drying Chamber

The first product stream containing the dewatered cereal grass is dropped though a drying medium in the first drying chamber of the system provided herein. Because of the dewatering accomplished using the second set of rolls, the amount of moisture remaining in the dewatered cereal grass is significantly reduced. This results in a more easily dryable cereal grass, as lower temperature drying medium and/or lower drying medium flow velocities are required to promote evaporation of the residual moisture in the dewatered cereal grass to achieve the targeted moisture content of the dried cereal grass. The rate of flow of drying medium within the first drying chamber and the temperature of the drying medium can be varied, and optimum flow and temperature can be determined. For example, the amount of drying medium at a given temperature required to absorb a targeted amount of moisture removed from the cereal grass can be measured and adjusted.

A cabinet encloses and defines the first drying chamber. The first drying chamber includes a product inlet for receiving the dewatered cereal grass from the second set of rolls. The first chamber also includes a product outlet for discharging the dried dewatered cereal grass from the first drying chamber, e.g., to a second drying chamber. After passing through the first drying chamber, e.g., via a conveyor, a product having the targeted moisture content emerges from the first drying chamber and can be transferred to a second drying chamber of the system.

The first drying chamber can be constructed of any material or combination of materials that allow the environment within the chamber to be separated from the external environment. For example, the first drying chamber can include walls of wood, plastic, fiberglass composite, metal or combinations thereof. In some configurations, the first drying chamber has wooden, aluminum or steel walls. The walls can be connected using any traditional fastening mechanism, such as screws, nails, glue, epoxy, ties, fasteners, angles, and combinations thereof. The first drying chamber can have an intake aperture and an exhaust aperture. The drying medium can be moved through the first drying chamber using any traditional air moving devices, such as fans and blowers. The drying medium used to remove moisture from the cereal grass can be any gas, such as air, nitrogen, or inert gas, such as argon. The drying medium typically has a low moisture content, such as less than 30% relative humidity, or less than 20% relative humidity, or less than 10% relative humidity, or less than 5% relative humidity.

The drying medium used in the first drying chamber, whether air, nitrogen or inert gas or combination thereof, can be dried to a target relative humidity for use in the first drying chamber. The amount of moisture in the drying medium can be reduced by subjecting the drying medium to compression, or reducing the temperature of the drying medium such as via refrigeration, or exposing the drying medium to a desiccant, or any combination of these methods. For reasons of economy, air is the preferred drying medium, although nitrogen or an inert gas such as argon can be used.

The drying medium can be the same temperature as the ambient environment. The drying medium can be warmer than ambient temperature. The temperature of the drying medium can be at least 40° C., or at least 50° C., or at least 60° C., or at least 70° C., or at least 80° C., or at least 90° C., or at least 100° C. The temperature of the drying medium can be in the range from about 40° C. to about 140° C., or from about 50° C. to about 150° C., or from about 60° C. to about 160° C.

The speed of the flowing drying medium can be at least 0.05 m/s, or at least 0.1 m/s, or at least 1.5 m/s, or at least 2.5 m/s, or at least 5 m/s. The drying medium flowing through a chamber can have an average speed of between about 0.05 and 10 m/s. High drying medium speed can cause turbulent flow within the chamber, which can promote mixing of the drying medium flowing through the chamber, increasing the rate of evaporation of water from the cereal grass within the chamber. In some configurations, the drying medium can have a volume flow of from about 50 cfm/ton of cereal grass to about 5500 cfm/ton of cereal grass, or from about 20 L/sec/tonne to about 275 L/sec/tonne.

The dewatered cereal grass can be moved through the first drying chamber using a conveyor. The conveyor includes a conveyor belt that forms a loop over at least two rollers. One of the rollers can be connected to a motor to drive the movement of the conveyor belt and thus convey the dewatered cereal grass on the conveyor belt through the drying chamber. In some configurations, a plurality of conveyors can be used, arranged one above another. When product reaches the end of one conveyor belt, the dried dewatered cereal grass can fall down to the next conveyor belt beneath it, allowing redistribution of the dried dewatered cereal grass on the second conveyor belt, which can result in exposure of different surfaces of the cereal grass to the circulating drying medium in the drying chamber. When the dried dewatered cereal grass reaches the end of last conveyor belt, the dried dewatered cereal grass is transferred to a conveyor that directs it out of the first chamber and, e.g., to a second drying chamber.

In some configurations, the conveyor can include a mechanical mixer positioned above at least one portion of the conveyor. The mechanical mixer can include a rotating wheel with projections, such as hook or talon-like extensions. The rotating wheel can be positioned so that the projections can engage with the dewatered cereal grass on the conveyor, picking up at least a portion of the dewatered cereal grass from the conveyor and flipping it over by bringing it up and over the rotating wheel in a circular motion. This mixing of the crop can further reduce drying time by mitigating wet spots or thick patches on the conveyor, and by exposing different surfaces to the drying medium. Such rotating wheel mechanical mixers can be positioned throughout the chambers of the device. The rotating wheel can include projections around the circumference of the wheel. The rotating wheel can include projections around only a portion of the circumference to allow some material to pass without engaging with the projections and being picked up by the rotating wheel.

The conveyor in the drying chamber can be of a material that has a resistance to reverse bending, has elastic resistance, is flexible, and has a surface resistant to various attacking agents (oxidizing or reducing agents) and is stable under various conditions (high moisture, variable temperature). In some configurations, the conveyor can include belts that are easy to install and to change, and are free of weak points. For example, joints can be reinforced to minimize any weakness at the joints. In some configurations, the conveyor can include a metal conveyor belt, such as a stainless steel conveyor belt, with perforations that allow the passage of the drying medium through the conveyor with minimal resistance.

A pair of guide ribs can be included on the underside of the conveyor throughout the length of the conveyor. The ribs can travel within annual grooves of equal dimensions and configurations formed within the rollers of the conveyor to aid in driving the conveyor and maintaining the conveyor in aligned relation with the rollers. The conveyor can include protrusions on its surface to interact with the dewatered cereal grass as it falls onto the conveyor. The protrusions can help pull the dewatered cereal grass through the drying chamber.

The conveyor can be driven by a variable speed electric motor and drive unit, which can be connected by a chain to a spur or gear mounted on one end of a roller. The rate of travel of the conveyor is variable, and can be adjusted depending upon the desired moisture content of the dried dewatered cereal grass. Other driving devices known in the art also can be used.

The conveyor in the first drying chamber can include perforations so that drying medium can pass through the conveyor. The conveyor can be made of any suitable material, such as metal, polyamide, nylon, thermoplastic block polymer. The conveyor in the first drying chamber can be configured to be in a horizontal position, or an inclined position, or in a spiral or combinations thereof. The drying system can include a stack of horizontal conveyor belts, such as from 2 to 10 conveyor belts, configured so that the end of one conveyor belt can deposit the cereal grass traveling on it to a conveyor belt beneath it in the stack. The drying system can include a string of inclined conveyor belts, such as from 2 to 10 conveyor belts, configured so that the end of one conveyor belt can deposit the cereal grass traveling on it to a conveyor belt following it in the string. An advantage of having more than two conveyors is that multiple drops from one conveyor to another can be achieved, which insures mixing of the product and even distribution of drying medium through the dewatered cereal grass as it moves through the first drying chamber.

In order to minimize any crop loss during the drying process, the dryer can include a diverter on the underside of the perforated conveyors. The diverter captures any material that might pass through the perforations of a conveyor and directs the captured material to the conveyor directly beneath it. The bottom-most conveyor can include a diverter that captures any lost material, which then can be fed back into the system by a separate conveyor that moves material from beneath the bottom-most conveyor to the upper-most conveyor of the chamber. In one configuration, the diverter includes an angled piece of sheet metal or plastic on each side of and below the conveyor, angled so that material passing through the perforated conveyer is directed down unto the conveyor directly beneath it.

In some configurations of the systems provided herein, the first drying chamber can include a circulation cycle for the drying medium circulating through the first drying chamber, resulting in an essentially closed system. For example, drying medium can enter the first drying chamber via an intake or manifold. The drying medium optionally can be heated. The drying medium passes through the first drying chamber, interacting with the dewatered cereal grass as it does so, removing moisture from the dewatered cereal grass as the dewatered cereal grass moves through the first drying chamber, such as on a conveyor. The drying medium can be driven through the first drying chamber using a blower unit. The blower unit can include a motor driven blower or fan or combinations thereof. The size and shape of the fan or blower can be selected to achieve a desired volume of air flow. When a fan is used, the fan can be a centrifugal fan or an axial fan or combinations thereof. Examples include radial fans, modified radial fans, backward curved airfoil, forward curved, multivane, paddle, inclined airfoil, vane axial, tube axial, centrifugal blower, positive-displacement blower, air foil, and propeller. One or more than one fan or blower can be used within the blower unit to achieve the desired volume of air flow through the first drying chamber. The blower unit can include a damper for controlling air flow rate. The fans or blowers can include inlet guide vanes to change the angle the air entering the device is presented to the fan blades. The blower unit(s) can be placed anywhere within the circulation cycle.

The interaction of the drying medium with the dewatered cereal grass results in the formation of a more moist drying medium due to the evaporation of moisture from the dewatered cereal grass. Evaporation of the moisture in the dewatered cereal grass also can result in the reduction in the temperature of the drying medium. The now moister cooler drying medium exits the first drying chamber via an exhaust aperture. The moister cooler drying medium then is exposed to a dehumidifier to remove moisture. The dehumidifier can include a compressor, or a desiccant, or a cooling surface, such as a cold heat exchanger, or combinations thereof. The dehumidifier removes water from the drying medium, thus forming a dehumidified drying medium. The dehumidified drying medium then can be heated by a hot heat exchanger resulting in a heated drying medium, which can be fed into the first drying chamber via an intake or manifold and used as the drying medium to remove moisture from the new dewatered cereal grass entering the first drying chamber.

In some configurations of the system, a refrigeration cycle (heat pump) can used as a heat exchanger. By using a heat pump, it is possible to move heat while significantly reducing the energy required to run the system compared to other drying devices. For example, for a heat pump rated with a coefficient of performance (COP) of 3.5, 3.5 kW of energy can be moved from the cold heat exchanger to the hot heat exchanger for every 1 kW of external electrical energy the heat pump consumes. In contrast, an electrical or gas heater would require 3.5 kW of supplied energy to have a similar heating effect, without the benefits of dehumidifying the air. A heat pump having a desired COP rating can be selected as the heat exchanger. Typical COP values are in the range of about 2 to about 4, which is about a tenth of the theoretical maximum. It is entirely possible that the actual COP is different from the rated COP (likely higher).

The high moisture drying medium venting from the first drying chamber can be directed to a cold evaporator of a heat pump. Upon passing over the cold evaporator of the heat pump, moisture in the drying medium condenses. The cold evaporator of the heat pump thereby extracts moisture and dries the drying medium. The cold and now drier drying medium then can be directed toward a warm condenser of the heat pump. Interacting with the warm condenser increases the temperature of the drying medium. Increasing the temperature of the drying medium increases its ability to hold moisture. The warm dry drying medium then can be directed to the intake of the first drying chamber by a fan or blower, travel through the first drying chamber extracting moisture from the dewatered cereal grass within the chamber, resulting in the formation of cool moister drying medium, which circulates through the treatment cycle again to be dehumidified and returned to the first drying chamber. The treatment cycle reconditions the drying medium so that is it warm and dry and can facilitate the evaporation of liquid.

Because the bulk of the moisture of the cereal grass has been removed by the press rollers of the second set of rolls, less energy is required to reduce the moisture of the cereal grass to the targeted moisture level. The drying medium passing through the first drying chamber can be sufficient to reduce the moisture level to a range between about 16% and 25% moisture.

Second Drying Chamber

Although the first drying chamber can sufficiently dry the dewatered cereal grass to a targeted moisture level, the expressed grass liquid can include nutrients that should be returned to the dewatered grass in order to maintain its nutritive value. To do so, the expressed grass liquid is pumped from its container to an atomizer in the second drying chamber to be applied to the dried dewatered cereal grass. In some configurations, the atomizer can be included in the first drying chamber, and the expressed grass liquid applied to the dried dewatered cereal grass while it is still in the first drying chamber.

In configurations that include a second drying chamber, a cabinet encloses and defines the second drying chamber. The second drying chamber includes a product inlet for receiving the dried dewatered cereal grass from the first drying chamber. The second drying chamber also includes a product outlet for discharging the dried coated cereal grass from the second drying chamber. After passing through the second drying chamber, e.g., via a conveyor, a product having the targeted moisture content emerges from the second drying chamber of the system.

The second drying chamber can be constructed of any material or combination of materials that allows the environment within the chamber to be separated from the external environment. The second drying chamber can be constructed using the same or different materials than used for the first drying chamber. For example, the second drying chamber can include walls of wood, plastic, fiberglass composite, metal or combinations thereof In some configurations, the second drying chamber has wooden, aluminum or steel walls. The walls can be connected using any traditional fastening mechanism, such as screws, nails, glue, epoxy, ties, fasteners, angles, and combinations thereof. The second drying chamber includes an intake aperture and an exhaust aperture. The drying medium can be moved through the second drying chamber using any traditional air moving devices, such as fans and blowers. The drying medium used to remove moisture from the cereal grass can be any gas, such as air, nitrogen, or inert gas, such as argon. The drying medium typically has a low moisture content, such as less than 30% relative humidity, or less than 20% relative humidity, or less than 10% relative humidity, or less than 5% relative humidity.

The drying medium used in the second drying chamber, whether air, nitrogen or inert gas or combination thereof, can be dried to a target relative humidity for use in the second drying chamber. The amount of moisture in the drying medium can be reduced by subjecting the drying medium to compression, or reducing the temperature of the drying medium such as via refrigeration, or exposing the drying medium to a desiccant, or any combination of these methods. For reasons of economy, air is the preferred drying medium, although an inert gas such as argon or nitrogen can be used.

The second drying chamber includes an atomizer above an application zone through which the dried dewatered cereal grasses passes. The atomizer converts the expressed grass liquid from the second set of rolls into a mist of small droplets. The expressed grass liquid can be withdrawn from the holding container into which it was deposited when extracted by the second set of rolls using a pump and line that delivers the expressed grass liquid to the atomizer. Internally of the second dryer chamber, the expressed grass liquid is sprayed by the atomizer, which produces small droplets of the expressed grass liquid, into the moving drying medium in the application zone of the chamber. Due to the action of the drying medium through which the droplets pass, the liquid in the small droplets of the expressed grass liquid evaporates, partially or completely, to produce a desired condensed grass extract, which then falls onto and at least partially coats the dewatered dried cereal grass.

Any atomizer, such as those commonly used in spray driers, can be used (e.g., see U.S. Pat. Nos. 4,117,801 (Dannelly et al., 1978); 4,226,603 (Larsson et al., 1980); 4,519,990 (Bevilaqua et al., 1985); 5,272,820 (Ito et al., 1993); 5,279,708 (Wood et al., 1994); 6,820,865 (Low, 2004); and 9,403,123 (Rafidi, 2016)). The atomizer can form droplets using spray nozzles or by high-speed spray wheels or discs or any combination thereof. The atomizer can include one or more pressure nozzles, or two-fluid nozzles, or a rotary atomizer, or combinations thereof In some applications, a single-stream atomizer is used to produce droplets of the expressed grass liquid.

The expressed grass liquid is introduced into the atomizer, which divides the expressed grass liquid it into a mist of fine droplets, and dispenses the mist of droplets into a stream of drying medium within the cabinet. Because of their small size, the droplets have a high surface area to volume ratio, and moisture in the droplets is rapidly vaporized, concentrating the liquid. In some applications, the majority of the moisture can be removed, producing particles of essentially dry solid material. Because of the high surface area to volume ratio of the droplets, very little thermal energy is required to evaporate the moisture of the droplets, increasing the energy efficiency of the drying system. The drying medium in the cabinet can be heated to provide additional thermal energy to the dispersed droplets, more quickly evaporating some or all of the water of the droplets to produce droplets of condensed grass extract, which can be deposited on a surface of the dried dewatered cereal grass as it passes under the zone of application. In some applications, the size of the droplets or the temperature of the air stream or both can be modulated so that at least a portion of the droplets contain moisture, allowing them to adhere to the surface of the dried dewatered cereal grass. The adhered droplets then can act as an adhesive so that dried droplets of expressed grass liquid can adhere to the surface, producing a coated dry cereal grass product. The coated dry cereal grass product can exit the drying system having a desired moisture content. When the dry product is to be baled, a target moisture content can be in the range of from about 16 wt % to about 22 wt %, or from about 18 wt % to about 22 wt %. If the moisture content is too low, leaf quality can be negatively impacted, such as producing a leaf that cracks or detaches during the baling process, resulting in leaf loss and dry cereal grass with a much higher proportion of stem to leaf.

The direction of flow of the droplets of expressed grass liquid and drying medium within the second drying chamber can be concurrent, countercurrent or a combination of both. When configured for concurrent flow, the mist of droplets exits the atomizer in the same direction as the flow of drying medium within the chamber in the zone of application. In a countercurrent configuration, the mist of droplets exits the atomizer in the opposite direction from the direction of flow of the drying medium in the chamber in the zone of application. Generally, the expressed grass liquid is introduced into the atomizer near the top of the chamber so that the droplets produced by the atomizer fall down toward the dewatered dried cereal grass, while the air flow in the chamber in the zone of application moves from the bottom to the top of the chamber in an upward direct, counter to the flow of the droplets.

The zone of application also can be configured to have a mixed-flow of drying medium, using both parallel and countercurrent flow. In this configuration, heated drying medium can be admitted to the chamber in the zone of application tangentially near the top of the chamber. The drying medium can be directed to spiral near the walls of the chamber, then to reverse direction and spiral upwardly near the center of the chamber, exiting through an outlet at the top of the chamber. The expressed grass liquid can enter the atomizer near the top of the chamber, and the atomizer can form a mist of droplets that fall downwardly. At least a portion of the liquid of the droplets evaporates, and the evaporated liquid passes upwards with the drying medium to exit the chamber, and the partially or completely dried droplets fall downward to at least partially coat the dewatered dried cereal grass passing through the application zone.

Before being directed to the atomizer, the expressed grass liquid can be modified. For example, additional nutrients can be added to the expressed grass liquid. The nutrient can be any one or a combination of a vitamin, an oil, a fatty acid, a fat, a mineral, an amino acid, a phospholipid, and an anti-oxidant. The fatty acid can be an omega 3 fatty acid, such as alpha-linolenic acid (ALA), eicosa-pentaenoic acid (EPA), and docosahexaenoic acid (DHA). The anti-oxidant can be a naturally-occurring anti-oxidant, such as Vitamin E, a tocopherol or mixed tocopherols, a carotenoid, a polyphenolic compound, ascorbic acid, eugenol, thymol, green tea extract, rosemary oil or extract, thyme white oil or combinations thereof.

Other additives can be added to the expressed grass liquid before the expressed grass liquid is directed to the atomizer. Exemplary additives include corn steep liquor, barley extract, yeast extract, waste from beer fermentation broth, molasses, enzymes such as phytases and glycanases, ionophores such as monensin sodium (Rumensin®) and lasalocid sodium (Bovatec®), probiotics including certain strains of Bifidobacterium, Enterococcus, Bacillus, and Lactobacillus, sodium bicarbonate, sodium sesquicarbonate, zinc methionine, an agent to prevent biological contamination, and combinations thereof. Exemplary agents to prevent biological contamination include acetic acid, ascorbic acid, benzoic acid, citric acid, phosphoric acid, propionic acid, sorbic acid, and salts and combinations thereof. The result is that these additives can be coated onto the cereal grasses as the cereal grasses are being processed through the drying system, producing a treated dried cereal grass.

The drying medium in the second drying chamber can be sufficient to dry the coated dry cereal grass to the targeted moisture level. In such instances, the coated dried cereal grass can exit the second drying chamber and can be baled by a conventional baler.

If the coated dry cereal grass has a moisture content above the targeted moisture level, the coated dry cereal grass can be conveyed into a third drying chamber for further processing to reduce the moisture level to within a targeted range.

Third Drying Chamber

The drying system provided herein optionally can include a third drying chamber for further conditioning of the coated cereal grass product. The third drying chamber can circulate a drying medium such as air at a prescribed moisture content through the coated cereal grass so that a final dried coated cereal grass having a targeted moisture content is produced. The third drying chamber includes conveyors that transport the treated cereal grass from the second drying chamber through a stream of drying medium in the third drying chamber to achieve a targeted moisture level in the dried coated cereal grass.

The dried coated cereal grass can be moved through the third drying chamber using a conveyor. The conveyor can be essentially of the same design as described for the first and second drying chambers. The conveyor can include a conveyor belt that forms a loop over at least two rollers. One of the rollers can be connected to a motor to drive the movement of the conveyor belt and thus convey the coated cereal grass on the conveyor belt through the drying chamber. In some configurations, a plurality of conveyors can be used, stacked one above the other. When product reaches the end of one conveyor belt, the dried coated cereal grass can fall down to the next conveyor belt beneath it, allowing redistribution of the coated cereal grass on the conveyor belt, which can result in exposure of different surfaces of the coated cereal grass to the circulating drying medium in the third drying chamber. When the dried coated cereal grass reaches the end of last conveyor belt, the dried coated cereal grass is transferred to a conveyor that directs it to an exit of the chamber.

The conveyor belts in the third drying chamber can be configured to be in a horizontal position, or an inclined position, or in a spiral or a combination thereof. The drying system can include a stack of horizontal conveyor belts, such as from 2 to 10 conveyor belts, configured so that the end of one conveyor belt can deposit the cereal grass traveling on it to a conveyor belt beneath it in the stack. The drying system can include a string of inclined conveyor belts, such as from 2 to 10 conveyor belts, configured so that the end of one conveyor belt can deposit the cereal grass traveling on it to a conveyor belt following it in the string. An advantage of having more than two conveyors is that multiple drops from one conveyor to another can be achieved, which insures mixing of the product and even distribution of drying medium through the coated cereal grass as it moves through the third drying chamber.

The optional third drying chamber optionally can be used as a post-drying treatment chamber. For example, product within the third drying chamber can be subject to a chemical treatment. The chemical treatment can be to further decrease moisture, such as by treating with a desiccant or with a higher temperature drying medium, or to increase nutritive value of the product, or both, such as by treatment with a desiccant, hydrogen peroxide, an acid, a protease, a carbohydrase, a preservative, or combinations thereof (e.g., see U.S. Pat. Nos. 4,123,552 (Kensler et al., 1978); 4,649,113 (Gould, 1987); 5,026,571 (Halliday, 1991); 5,720,971 (Beauchemin et al., 1998); 5,922,343 (1999, Stucker); 5,948,454 (Virkki et al., 1999); and 8,815,316 (Duan et al., 2014); and U.S. Pat. Appl. Pub. Nos. US2012/0128816 (Ametaj, 2012). Exemplary preservatives include propionic and acetic acid. Application of solutions of propionic or acetic acid or combinations thereof results in inhibition of the growth or aerobic microorganisms, including bacterial and fungal species. The organic acids also can prevent excessive heating during storage. Application of a preservative after drying can allow the crop to be baled at a higher moisture content than if untreated. The amount of preservative needed can depend on the moisture content of the crop. For example, for alfalfa hay containing 32% water, application of 1 wt % aqueous propionic acid (equivalent to about 20 pounds per ton of crop) was effective. Solutions containing up to about 20 wt %, or up to about 30 wt %, or up to about 40 wt %, or up to about 50 wt %, or up to about 60 wt %, or up to about 70 wt % propionic acid can be used for application.

The drying systems provided herein also can include a cleaning system. Because warm, moist areas tend to facilitate the growth of mold and bacteria, the drying system should be cleaned after each use. To facilitate cleaning, the dryer can include sprayers that can apply a cleaning solution to all surfaces within the chambers of the system. The system also can include a draining system, such as at the bottom of each chamber, that allows cleaning solutions to be removed from the system and recovered for treatment of the waste stream, if needed. The sprayers can be connected to a pressurizing system, such as pumps or compressed gas, to spray the cleaning solution with some force within the chambers of the system to ensure that all surfaces are reached by the cleaning solution. The cleaning solution can be acidic or alkaline, and can include surfactants, solvents or combinations thereof. The surfactants can be selected to be low residue surfactants. The low-residue surfactant can be an alkylpolysaccharide or alkyl glycoside, an amide oxide or an anionic surfactant, or any combination thereof. Exemplary alkylpolysaccharide and alkyl glycoside surfactants are described in U.S. Pat. Nos. 4,565,647 (Llenado, (1986)); 5,776,872 (Giret et al., (1998)); 5,883,059 (Furman et al., (1999)); 5,883,062 (Addison et al., (1999)); and 5,906,973 (Ouzounis et al., (1999)). The cleaning solution can include an organic carboxylic acid. The organic carboxylic acid can be selected from among acetic acid, citric acid, gluconic acid, glucuronic acid, hydroxyacetic acid, lactic acid, propionic acid and combinations thereof. The organic carboxylic acid can be present in an amount from about 0.01 wt % to about 15 wt % based on the weight of the cleaning solution composition. The cleaning solution can include a food grade mineral acid, such as phosphoric acid. The phosphoric acid can be present in an amount from about 0.1 wt % to about 50 wt %. The cleaning solution can include a solvent. The solvent can comprise a C₁-C₆ alkoxy ethanol, a C₁-C₆ (alkoxyethoxy)ethanol, an alkylene glycol mono-C₁-C₆-alkyl ether, C₂-C₆ alkanol, or any combination thereof. When present, the solvent can comprise from about 0.1 wt % to about 10 wt % of the cleaning solution.

The cleaning solution can allow the sprayers to apply a solution within the dryer system to result in a clean-in-place method for removing protein-based and/or carbohydrate-based deposits on device surfaces. The method includes steps of contacting surfaces within the dryer system unit with the cleaning solution and then removing the composition from the drying unit. In some methods, the cleaning methods include a first rinse with water followed by the application of the cleaning solution. The cleaning solution then can be removed, such as by applying a rinse with potable water. The cleaning solution can be allowed to remain in contact with surfaces of the dryer system for some time before being removed. In some applications, the cleaning solution can be allowed to remain in contact with the surfaces for a time period of from about 30 seconds to about 30 minutes. The method of cleaning also can include one or more contacting steps in which an aqueous rinse with hot, warm or cold water, acidic solution, alkaline solution, solvent or other cleaning composition can be contacted with the equipment at any step during the process.

Computer System

The drying systems provided herein can include a computer for partial or complete automation of the system. The computer can be in communication with and/or in control of any part of drying system, including the pre-treatment rollers, the conditioner, the pressing rollers, the vacuum systems, any heating device(s), the fan(s) or blower(s) of the drying chamber(s), the pumps of the sprayers, the conveyors, heat exchanger(s), and air compressor(s). The computer can control or allow automation of any component of the drying system In the systems provided herein, the computer module can include a non-transitory computer-readable storage medium having a computer-readable program embodied therein for directing operation of the drying system and/or any component of the drying system. The computer can adjust the nip width and pressure according to an input description of the type of crop being processed. The computer can adjust the flow and speed of the drying medium throughout the chamber(s). The computer can be in communication with sensors within the chamber, such as temperature and humidity sensors, and can adjust the flow of drying medium in accord with predetermined temperature and humidity parameters. The computer can be programmed to be self-optimizing based on the sensors within the chamber to adjust temperature, speed and volume flow to optimize drying and efficiency of the system.

The computer can provide a selectable operational mode that would allow a farmer to enter the type of crop to be processed, and the computer would adjust the components of the system to dry the type of crop designated. This allows the farmer to use the same drying system to process legumes such as alfalfa as well as grasses, such as Timothy grass. This provides versatility, customizability and ease of use to the farmer. The computer also can monitor wear of the equipment during use, providing a warning when a component needs adjusting or replacement, minimizing any downtime of the system due to component failure.

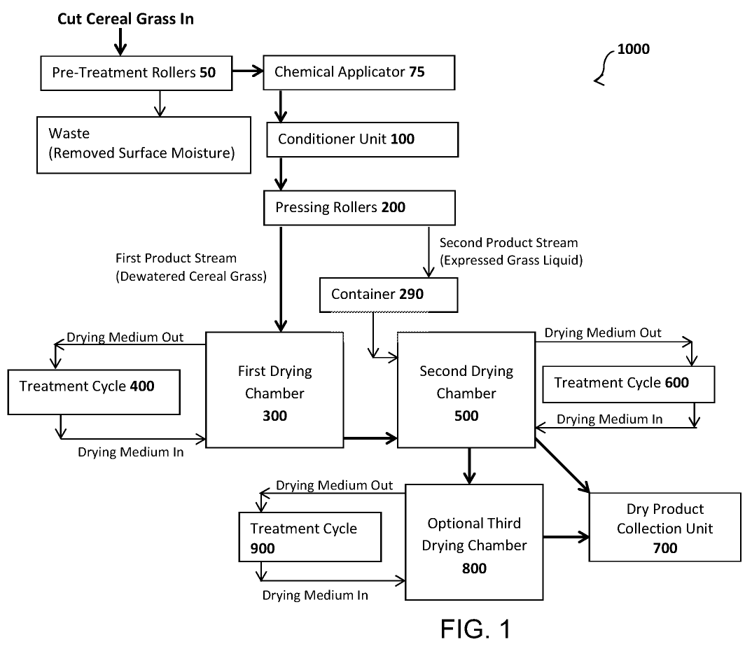

Referring now to the figures, in which like reference numerals indicate like or corresponding features, FIG. 1 is a schematic diagram of a basic process flow of an exemplary configuration of the drying system 1000 provided herein. The exemplified system includes pre-treatment rollers 50 that can remove surface moisture from the cut cereal grass, a chemical applicator 75 for applying a chemical solution, such as an aqueous solution of potassium carbonate, sodium carbonate, sodium hydroxide and combinations thereof, onto at least one surface of at least a portion of the cereal grass. The treated cereal grass then passes through a conditioner unit 100, which facilitates faster drying by crimping, crushing and/or fracturing the cereal grass to facilitate removal of the moisture in the cereal grass. The conditioned cereal grass then passes through pressing rollers 200 for expressing liquid out of the cut cereal grass to produce a first product stream containing dewatered cereal grass, which is directed to a first drying chamber 300, and a second product stream containing the expressed grass liquid, which is directed to a container 290. The dewatered cereal grass enters the first drying chamber, where the drying medium passes over and through the dewatered cereal grass passing through the chamber, thereby reducing the moisture content of the dewatered cereal grass. The first drying chamber 300 includes a drying medium treatment cycle 400 for conditioning the drying medium. The treatment cycle 400 can remove any moisture in the drying medium evaporated from the dewatered cereal grass.

The dried cereal grass exits the first drying chamber 300 and enters a second drying chamber 500, where the expressed grass liquid from the container 290 is atomized and applied to the dried cereal grass to produce a coated cereal grass. The second drying chamber 500 optionally includes a drying medium treatment cycle 600 for conditioning the drying medium. The treatment cycle 600 can remove any moisture in the drying medium evaporated from the cereal grass. The drying medium in the second drying chamber 500 can be sufficient to reduce the moisture content in the coated cereal grass to a targeted moisture content, and then the dried coated cereal grass can be directed to the dry product collection unit 700 for further processing, such as baling.

After the moisture content of the dewatered cereal grass has been reduced in the first drying chamber 300, it can directed to the second drying chamber 500. In drying chamber 500, the dried cereal grass is conveyed on a conveyor through the chamber, during which time an atomizer sprays the expressed grass liquid from container 290 into the drying medium, forming a fine mist of droplets of the expressed grass liquid. Due to the interaction with the drying medium in the chamber, moisture in the droplets of expressed grass liquid evaporates, condensing the droplet. Depending on the size distribution of the droplets, some of the droplets may completely lose their liquid content due to evaporation, resulting in dry particles. The condensed droplets fall on the dried dewatered cereal grass on the conveyor, and the dried particles of expressed grass liquid fall on the dried cereal grass as well, adhered to the surface by the droplets of condensed expressed grass liquid coating the surface. The resulting coated cereal grass continues to be moved through the drying chamber on the conveyor, with drying medium interacting with it as it moves, further reducing the moisture content of the coated cereal grass. Once the coated cereal grass has reached a desired moisture content, it can be diverted out of the second drying chamber to a dry product collection unit 700. Alternatively, the dried coated cereal grass can be conveyed into a third drying chamber for subsequent treatment.

The second drying chamber 500 can include a drying medium treatment cycle 600 for conditioning the drying medium. The drying medium enters the second drying chamber, circulates around the dewatered cereal grass and coated cereal grass to evaporate liquid from the dewatered cereal grass, droplets of expressed grass liquid and coated cereal grass. In doing so, the drying medium loses thermal energy and its moisture content increases. This cooler, moister drying medium then can be directed out of the drying chamber into a treatment cycle 600, where it is dehumidified and warmed for recirculation back through the drying chamber. In alternate configurations, the drying medium, once cooled and containing moisture from the dewatered cereal grass and coated cereal grass and droplets of expressed grass liquid, can be vented to the environment outside of the chamber.

The drying system can include an optional third drying chamber 800 for further processing the dried coated cereal grass. The optional third drying chamber 800 optionally can be used as a post-drying treatment chamber. For example, product within the third drying chamber can be subject to a chemical treatment. The chemical treatment can be to further decrease moisture, such as by treating with a desiccant or with a higher temperature drying medium, or to increase nutritive value of the product, or both, such as by treatment with a desiccant, hydrogen peroxide, an acid, a protease, a carbohydrase, a preservative, or combinations thereof (e.g., see U.S. Pat. Nos. 4,123,552 (Kensler et al., 1978); 4,649,113 (Gould, 1987); 5,026,571 (Halliday, 1991); 5,720,971 (Beauchemin et al., 1998); 5,922,343 (1999, Stucker); 5,948,454 (Virkki et al., 1999); and 8,815,316 (Duan et al., 2014); and U.S. Pat. Appl. Pub. Nos. US2012/0128816 (Ametaj, 2012). The optional third drying chamber 800 optionally can be used to equilibrate the dried coated cereal grass to a targeted moisture content. The traverse time through the chamber can be adjusted to allow additional moisture to be evaporated from the dried coated cereal grass. Once a targeted moisture content is achieved, the dried coated cereal grass can be diverted out of the third drying chamber to a dry product collection unit 700. The dried coated cereal grass then can be baled using traditional baling techniques.

The third drying chamber 800 can include a drying medium treatment cycle 900 for conditioning the drying medium. The drying medium enters the third drying chamber, circulates around the coated cereal grass to evaporate liquid from the coated cereal grass. In doing so, the drying medium loses thermal energy and its moisture content increases. This cooler, moister drying medium then can be directed out of the drying chamber into a treatment cycle 900, where it is dehumidified and warmed for recirculation back through the drying chamber. In alternate configurations, the drying medium, once cooled and containing moisture from the coated cereal grass, can be vented to the environment outside of the chamber.

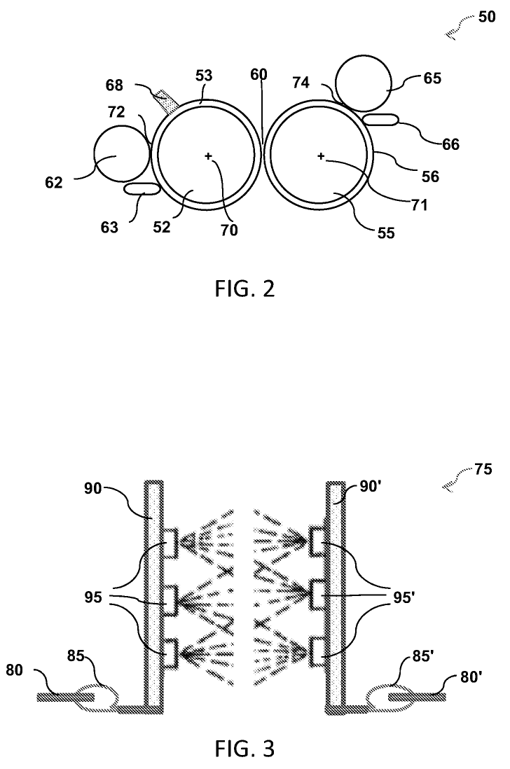

FIG. 2 shows an exemplary configuration of the pre-treatment rolls 50 that can remove surface moisture from the cut cereal grass. This allows harvesting early in the day when the crop may have dew or other moisture on its surface. It also allows the crop to be harvested if an unexpected rain occurs prior to or during harvesting. As shown in the figure, a first roll 52 having a covering 53 and a second roll 55 having a covering 56 are brought together to form a nip 60 through which the cut cereal grass can pass. The coverings 53 and 56 include an absorbent material that can absorb and wick water away from the cereal grass as it passes through the nip 60. The coverings 53 and 56 can include a pattern of protrusions or depressions of between 0.1 to 2.5 mm in depth in order to promote water wicking. The coverings 53 and 56 typically are compressible and can conform to the shape of the cereal grass passing through the nip 60 to absorb surface moisture. The coverings 53 and 56 return to their original shape after the cereal grass has passed through the nip 60.

The pressing rolls 52 and 55 shown in FIG. 2 also include a dewatering roll 62 in contact with covering 53 of roll 52 and a dewatering roll 65 in contact with covering 56 of roll 55. The dewatering rolls 62 and 65 compress the coverings 53 and 56, respectively, to press and remove the absorbed moisture from the coverings. The dewatering rolls 62 and 65 are of a hard material, such as steel, stainless steel or non-compressible rubber or other polymer. Each of the dewatering rolls 62 and 65 includes an assembly that includes at least one suction device for aspirating the water removed from the coverings 53 and 56 by the action of the dewatering rolls 62 and 65. The aspirated water collected by the suction devices can be directed to a pipe or hose for disposal.

As depicted in FIG. 2, the suction devices can be positioned anywhere about the press rolls as long as the suction device(s) do not interfere with the passage of the cereal grass through the nip 60. In one configuration, a suction device 63 can be positioned at or near the nip 72 formed between dewatering roll 62 and covered roll 52 to collect the water pressed out of the covered roll 52. The suction device 63 can extend in a direction parallel to the axis of the covered roll 52. The suction device 63 can be positioned such that it sealingly engages an outer surface of the covered roll 52 such that a delimited suction zone is formed in the area between the suction device 63, the outer surface of the covered roll 52 and the dewatering roll 62. In the delimited suction zone, water that has been pressed out of the covered roll 52 by the action of the dewatering roll 62 can be aspirated and removed by the suction device 63.

Also shown in FIG. 2, another suction device 68 can be located on the other side of the nip 72 produced between the covered roll 52 and the dewatering roll 62. The suction device 68 can further remove moisture from the covering 53 of the covered roll 52 before the covering 53 is brought into contact with more cereal grass. The suction device 68 can be placed in close proximity to the nip 72 or can be placed closer to the nip 72, so long as its position does not interfere with the passage of cereal grass through nip. Either or both covered rolls can include a suction device in the vicinity of the nip produced between the dewatering roll and the covered roll. As shown in FIG. 2, both covered roll 52 and covered roll 55 include suction devices. A suction device 66 is located in the vicinity of nip 74 formed between dewatering roll 65 and covered roll 55 to aspirate and remove water pressed out of covering 56 by the action of dewatering roller 65. Either or both covered rolls can include one or a plurality of suction devices to remove water or moisture from the covering of the rolls. Not shown in the figure are actuators that bring the covered rolls 52 and 55 together form the nip 60 between the rolls so that the cereal grass that passes through nip 60 will be pressed into the compressible coverings 53 and 56 so that surface moisture on the cereal grass can be absorbed and wicked away by the coverings 53 and 56. One of the rolls or both of the rolls can be provided with a drive for driving the roll(s). Also not shown in the figure are actuators that bring dewatering roll 62 into contact with covered roll 52 and that bring dewatering roll 65 into contact with covered roll 55.

Covered roll 52 has a central axis 70 and covered roll 55 has a central axis 71. Each of the rolls can be mounted to a stand via a connector positioned at the central axis of each roll. One of the covered rolls or both covered rolls can be provided with a drive for driving the roll(s). The drive can be connected to the covered role using conventional technology, such as via gears or a chain drive connected to a motor, such as a variable speed motor.

After passing through the pre-treatment rolls, the surface-dried cut cereal grass can be directed to a chemical applicator unit 75, as shown in FIG. 3. The chemical applicator unit 75 includes a frame 90 on a first side and a frame 90′ on a side opposite of the first side. The frames 90 and 90′ support a plurality of atomizing spray nozzles 95 and 95′, respectively. A metering pump 85 connects the spray nozzles 95 to a supply line 80, which supplies the chemical solution to be applied by the spray nozzles 95. A metering pump 85′ connects the spray nozzles 95′ to a supply line 80′, which supplies the chemical solution to be applied by the spray nozzles 95′. An electrical control can be used to actuate the metering pumps to provide a supply of chemical solution to the spray nozzles as desired.

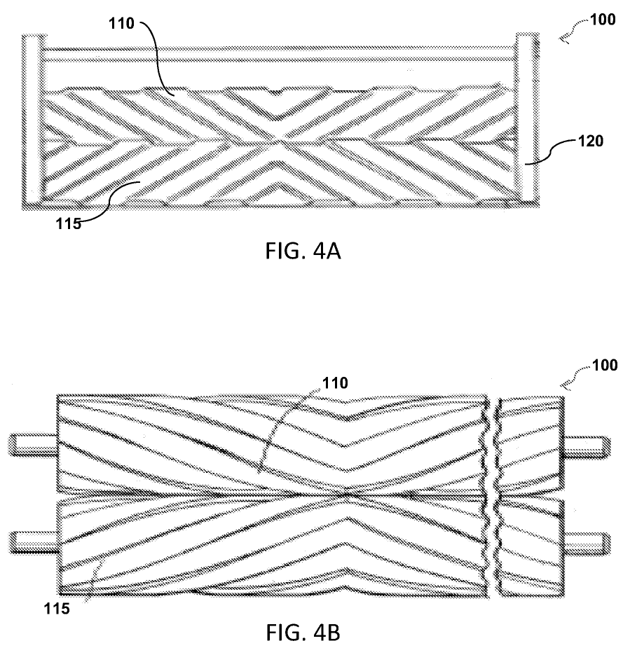

After passing through the chemical applicator unit, when a chemical solution optionally is applied, the treated cut cereal grass is directed to conditioner unit 100. As shown in FIG. 4A, a pair of conditioner rolls 110 and 115 are mounted on a frame 120. The length of the conditioner rolls 110 and 115 generally corresponds to the width of the crop discharge gap. The rolls 110 and 115 have intermeshing spiral grooves that crimp the cereal grass as it passes between the rollers 110 and 115, conditioning it in a known manner. As shown in FIG. 4B, the ribs of the lower roller 115 and ribs of the upper roller 110 can be arranged in complementary fashion in a quasi-herringbone configuration. The crushing action is achieved by the rib-to-rib contact. Spacing between ribs results in characteristic crimping of the cereal grass or forage crop.

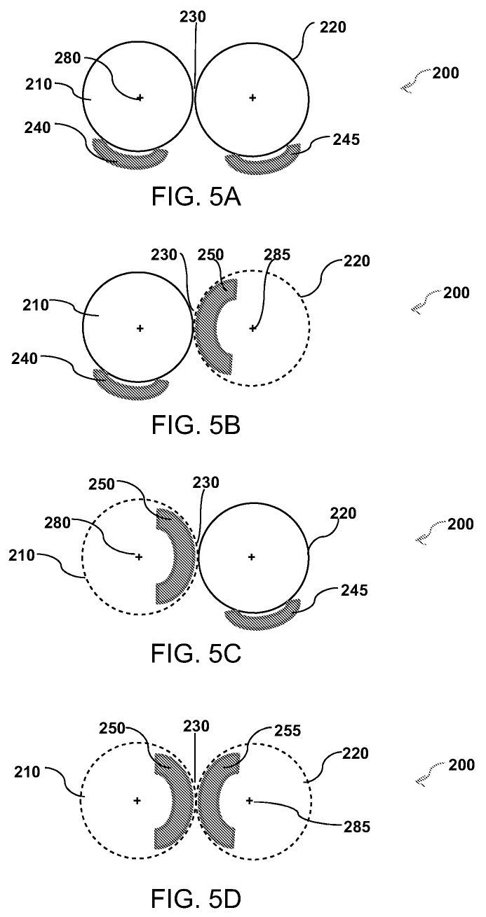

After passing through the conditioner unit, the treated cut cereal grass is directed to pressing rolls 200. Exemplary configurations of the pressing rolls are depicted in FIGS. 5A-5D. The second set of rolls includes a roll 210 and a roll 220 that form a nip 230 through which the cereal grass is pressed. The pressing rolls 210 and 220 are of a hard material, such as steel, a stainless steel or a non-compressible rubber or polymer. In some configurations, the rolls of the second set of rolls each can have an imperforate surface, as depicted in FIG. 5A. In some configurations, one of the rolls of the second set of rolls can have an imperforate surface and the other roll of the second set of rolls can have a perforated surface, as depicted in FIGS. 5B and 5C. In some configurations, the rolls of the second set of rolls each can have a perforated surface, as depicted in FIG. 5D.

Each of the pressing rolls 210 and 220 includes at least one suction device for aspirating and collecting the expressed grass liquid pressed from the cereal grass by the compression of the cereal grass in the nip 230 between the pressing rolls 210 and 220. As shown in FIG. 5A, a suction device 240 is associated with pressing roll 210 and suction device 245 is associated with pressing roll 220. Each of the suction devices 240 and 245 apply a reduced pressure or vacuum along at least a portion of the length of the pressing rollers to aspirate the liquid expressed from the cereal grass by the force of nip 230 and transfer the expressed grass liquid to a holding container such as container 290 in FIG. 1. Pressing roll 210 has a central axis 280 and pressing role 220 has a central axis 285.

The suction device 240 or 245 or both can extend in a direction parallel to the axis of the pressing roll with which it is associated and can be positioned such that it sealingly engages an outer surface of the pressing roll such that a delimited suction zone is formed in the area between the suction device and the press roll. In the delimited suction zone, expressed grass liquid that has been pressed out of the cereal grass due to the compressive forces of the pressing rolls at the nip 230 can be collected via suction device 240 or 245 or both and transferred to a holding container 290. Transfer can occur via gravity or by the use of a pump. In some configurations, the suction device sealingly engages the outer surface of the pressing roll by means of a first seal that extends in the axial direction of the pressing roll (which is also the axial direction of the suction device).

In some configurations, one or both of the rolls of the second set of rolls can be perforated, allowing the expressed juices from the cereal grass to pass into the interior of the roll(s) and be collected, such as by use of an aspiration funnel or suction device inside the roller. Exemplary configurations including at least one perforated roller are shown in FIGS. 5B-5D. In such configurations, the pressing roll containing a perforated surface can be a tube or roll shell instead of a solid cylinder. The surface perforations extend through the tube or shell and into the central opening of the tube or roll. This is depicted in roll 220 of FIG. 5B, roll 210 of FIG. 5C, and rolls 210 and 220 of FIG. 5D. The perforated tube or role shell has a thickness sufficient to exert the compression forces needed to extract the liquid from the cereal grass without deforming. In some configurations, the second set of rolls includes a roll that has no perforations and a roll that contains perforations, as shown in FIGS. 5B and 5C.

In configurations that include a perforated tube or roll shell, at least one suction device can be positioned within the perforated tube or roll shell to collect the expressed grass liquid. In FIG. 5B, suction device 250 is located with perforated roll shell 220 in the vicinity of the nip 230. The suction device 250 can be positioned so that it extends in a direction parallel to the axis of the pressing roll and sealingly engages an inner surface of the perforated roll shell 220 such that a delimited suction zone is formed in the area between the suction device 250 and the perforated roll shell 220. In the delimited suction zone, expressed grass liquid that has been pressed out of the cereal grass due to the compressive forces of the pressing rolls 210 and 220 at nip 230 can be aspirated and transferred to a holding container. Transfer of the aspirated expressed grass liquid can occur via gravity or by the use of a pump. In some configurations, the suction device 250 sealingly engages the inner surface of the perforated roll shell 220 by means of a first seal that extends in the axial direction of the perforated roll shell 220.

Imperforate roll 210 includes a suction device 240, which applies a reduced pressure or vacuum along at least a portion of the length of imperforate roll 210 to aspirate the liquid expressed from the cereal grass by the force of nip 230 and transfer the expressed grass liquid to a holding container. The suction device 240 can extend in a direction parallel to the axis of the imperforate roll 210 and can be positioned such that it sealingly engages an outer surface of the imperforate roll 210 such that a delimited suction zone is formed in the area between the suction device 240 and the imperforate roll 210. In the delimited suction zone, expressed grass liquid that has been pressed out of the cereal grass due to the compressive forces of the pressing rolls at the nip 230 can be collected via suction devices 240 and 250 and transferred to a holding container.

A similar configuration is shown in FIG. 5C. A perforated roll shell 210 and imperforate roll 220 are brought together to form a nip 230. At least one suction device can be located inside perforated roll shell 210. The suction device 250 can be arranged to aspirate and collect the expressed grass liquid pressed out of the cereal grass by the force of the nip 230 as the cereal grass passes through the nip 230. The suction device 250 can include an axially extending seal that engages an inner surface of the perforated roll shell 210 such that the suction device 250 sealingly engages the perforated roll shell 210. The axially extending seal can be substantially parallel with the axis of the perforated roll shell 210 and can be arranged to seal against the perforated roll shell 210. The axially extending seal can be made of different materials. The axially extending seal can include an elastic polymer. For example, the axially extending seal can be, wholly or in part, made of rubber, polyacrylate rubber, inert silicone elastomer (Silastic), polysiloxane, fluorosilicone, chlorosulfonated polyethylene, polyisoprene, neoprene, fluoropolymer elastomer (Viton) and combinations thereof.

A configuration in which both pressing rolls are perforated roll shells is shown in FIG. 5D. As shown, a perforated roll shell 210 is pressed against a perforated roll shell 220 to form nip 230. A suction device 250 is located within perforated roll shell 210. A suction device 255 in located within perforated roll shell 220. One or both of the suction devices 250 and 255 can extend in a direction parallel to the axis of perforated roll shell with which it is associated. The suction devices 250 and/or 255 can have an axial length that is substantially as long as the axial length of the perforated roll shell with which it is associated. When the suction device 250 and/or 255 extends for at least the entire axial length of the perforated roll shell with which it is associated, the reduced pressure or vacuum that it can create can operate over the entire axial length of the nip 230 of the second set of rolls. Liquid that has been pressed out of the cereal grass by the force applied at the nip 230 as the cereal grass passes through the nip 230 can be removed by the action of the suction device 250 and/or 255. The suction device 250 and/or 255 can be positioned so that the reduced pressure or vacuum can be applied directly at the exit from the nip 230 or at the entry to the nip 230, depending on whether the suction device is positioned downstream of or upstream of the nip 230. In some configurations, one or more suction devices can included on each side of the nip 230, allowing fluid expressed from the cereal grass to be removed by suction on both sides of the nip 230. In some configurations, such as those illustrated in FIGS. 5A-5D, a suction device can be configured so that the reduced pressure or vacuum produced by the device extends to each side of the nip 230, allowing fluid expressed from the cereal grass to be removed by suction on both sides of the nip 230. Expressed grass liquid collected by the suction devices 250 and/or 255 can be collected in a container for later application back to the dried dewatered cereal grass.

When the second set of rolls include a perforated roll shell as a pressing roll, the perforations can be of any shape. Exemplary shapes include square, rectangular, circular, oval and triangular. The average perforation diameter can be in the range of from about 0.1 mm to about 5 mm. The perforations can be distributed in any pattern on the perforated roll shell. For example, the perforations can be placed in parallel lines that spiral from one end of the roll shell to the other. The perforations can be distributed in a checkerboard pattern, with each collection of perforations creating a square, circular or triangular design. Some of the perforations can be created from the inside to the outside of the perforated roll shell, resulting in protrusions that can grab onto the cereal grass and pull it through the nip. The protrusions do not interfere with the nip or the force exerted at the nip.

The number of perforations in a perforated roll shell can depend on the thickness of the perforated roll shell, as a thicker roll shell can accommodate more perforations while maintaining sufficient physical strength to exert the necessary compression force on the cereal grass to express the liquid from the grass. The perforations in the roll shell result in a collective open area in the roll shell in the range of from about 5% to about 50%. The open area can be selected depending on the cereal grass to be processed to achieve a good expression of liquid from the cereal grass while maintaining sufficient strength of the roll shell.

In configurations in which the second set of rolls includes a roll shell with perforations, an air jet can be included inside the roll shell to blow a stream of air through the perforations from the inside to the outside to remove any debris and minimize any clogging.

The pressing rolls or pressing roll shells can be contained in a roll stand. Actuators, e.g., hydraulic, pneumatic, mechanical or electronic actuators, can be suitably arranged to force the second pressing roll or pressing role shell against the first pressing roll or pressing role shell to form a nip, such that the nip can be loaded with and pass through the nip cereal grass to be dewatered by being compressed by the force in the nip. The actuators can modulate the force at the nip in order to extract the liquid from the cereal grass. One of the rolls or both rolls can be provided with a drive for driving the roll.

The second set of rolls also can include a blade or brush to remove any material that could become adhered to the roll. The blade or brush can be positioned so that it scours the surface of the rolls after the nip, depositing any material removed from the rolls with the dewatered grass that passes through the nip. This can assure that no cereal grass material builds up on the roller and all of the cereal grass material is recovered.

The amount of pressure required at the nip to effectively extract the liquid from the cereal grass will depend on the cereal grass being processed. In most applications, a linear load can be applied at the nip (formed in the second set of rolls by the pressing rolls) in the range of about 50 kN/m to about 4,000 kN/m, or 100 kN/m to about 3,000 kN/m, or 500 kN/m to about 2,000 kN/m, or 50 kN/m to about 2,000 kN/m, or 100 kN/m to about 1,000 kN/m. Such a force generally is sufficient for effective extraction of liquid for many of the cereal grasses. When more resilient material, such as stocks of maize, are to be processed, a force in the range of from about 200 kN/m to about 4,000 kN/m may be necessary for effective extraction of liquid. Linear loads higher than 4,000 kN/m or lower than 50 kN/m can be used for some cereal grasses or portions thereof.

After the grass passes through the nip of the second set of rolls, it is a dewatered cereal grass that is directed to the first drying chamber.

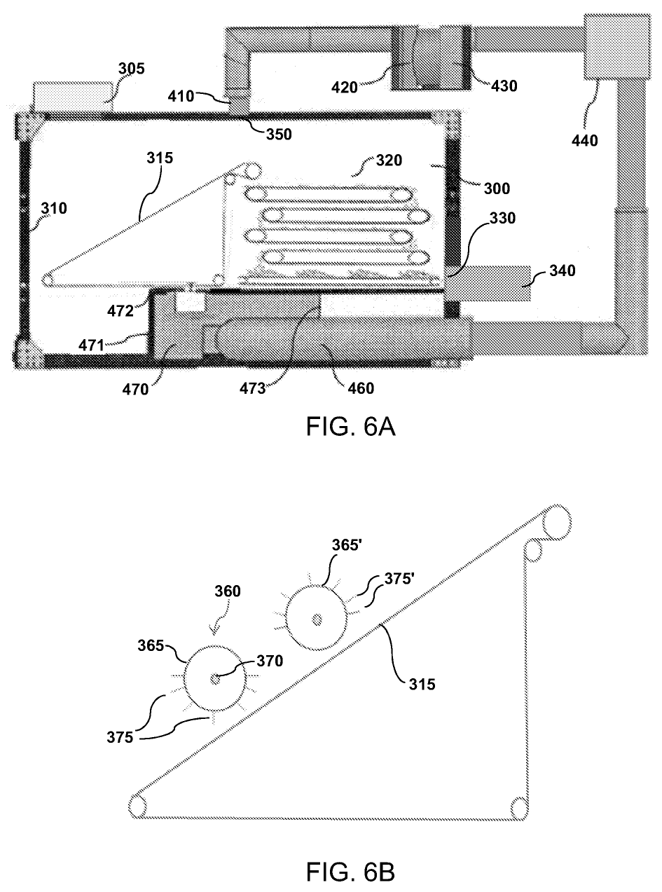

The basic process flow through the first drying chamber is shown schematically in FIG. 6A. As illustrated, the first drying chamber 300 includes a cabinet 310 enclosing and defining a drying chamber 300 having a product inlet 305 and a product outlet 330. The product outlet 330 is connector to connector 340, which can be connected to outer parts of the system, such as a second drying chamber or dry product collection unit. The dewatered cereal grass from the second set of rolls 200 is introduced into drying chamber 300 via product inlet 305. A drying medium is blown into the chamber 300 via a manifold 470 by the action of a blower 460. The manifold 470 can include a plurality of openings. In the configuration shown in FIG. 6A, manifold 470 includes three openings, manifold outlet 471, manifold outlet 472, and manifold outlet 473.

Outlet 471 is positioned so that the drying medium is blown up through the perforated conveyor 315 and into the dewatered cereal grass, evaporating moisture from the grass as it falls through the updraft of flowing drying medium moving toward the top of chamber 300. The freely falling dewatered cereal grass is not hampered by being layered on other dewatered cereal grass as it enters the chamber, and thus a large surface area of the freely falling dewatered cereal grass is exposed to the drying medium from outlet 471 before it contacts a conveyor belt. The drying medium that passes through the falling dewatered cereal grass becomes moist due to evaporative liquid removal from the dewatered cereal grass by the drying medium. This cooler moister drying medium can exit the chamber 300 via air exhaust aperture 350. Thus, the moistened drying medium produced when the stream of drying medium from outlet 471 passes through the falling dewatered cereal grass can be removed from the drying chamber 300 so that it does not contribute moisture to the dewatered cereal grass newly entering the chamber 300.

After freely falling through the updraft of dry drying medium, the dewatered cereal grass lands on conveyor belt 315 to form a loose layer of material. The conveyor belt 315 is perforated and allows dry drying medium from outlets 471 and 472 to pass through the conveyor belt 315 up through the mat of product. An advantage of this configuration is that the dewatered cereal grass is more evenly distributed onto the conveyor belt and not compressed, allowing drying medium to pass from the bottom through the layer of dewatered cereal grass, resulting in a more uniform removal of moisture from the dewatered cereal grass.

Outlet 472 in positioned beneath the perforated conveyor 315 and blows a separate stream of drying medium around the dewatered grass and through the pile of dewatered grass as it moves upward on the perforated conveyor 315 toward the top of the chamber 300. At the end of perforated conveyor 315, the drier dewatered cereal grass is deposited onto the first of a sequence of horizontally arranged perforated conveyor belts of conveyor system 320. Outlet 473 blows a separate stream of drying medium through the perforated conveyor belts of conveyor system 320 to remove additional moisture from the dewatered cereal grass as it traverses the perforated conveyor belts of conveyor system 320. The speed of the conveyor belts, the flow of the drying medium, and the number of conveyor belts of conveyor system 320 can be adjusted to yield a dried dewatered cereal grass having a targeted moisture content.

In the configuration depicted in FIG. 6A, conveyor system 315 includes a belt forming a loop over four rollers to form a continuous loop. Any of the rollers can be connected to a variable speed motor, the movement of which results in movement of the conveyor belt. Dewatered cereal grass is transported upwardly by conveyor system 315 to a bank of horizontally arranged conveyors of conveyor system 320, positioned so that the direction of the conveyors alternate in direction in order to maximize the drying time within the chamber using a minimum of space. In the configuration shown in FIG. 6A, the first conveyor belt of conveyor system 320 near the top of chamber 300 accepts dried dewatered cereal grass from conveyor 315 and transports it away from conveyor 315. When the dried dewatered cereal grass reaches the end of the first conveyor belt of conveyor system 320, the dried dewatered cereal grass falls down to conveyor belt directly underneath it, which moves in a direction toward conveyor 315. When the dried dewatered cereal grass reaches the end of this second conveyor belt, the dried dewatered cereal grass falls down to a third conveyor belt under the second belt. The direction of the third belt is opposite to that of the belt directly above it. When the dried dewatered cereal grass reaches the end of this third conveyor belt, the dried dewatered cereal grass falls down to a fourth conveyor belt under the third belt. The direction of the fourth belt is opposite to that of the belt directly above it. When the dried dewatered cereal grass reaches the end of this fourth conveyor belt, the dried dewatered cereal grass falls down to a fifth conveyor belt under the fourth belt. The direction of the fifth belt is opposite to that of the belt directly above it. At the end of the fifth conveyor belt, the dried dewatered cereal grass exits chamber 300 via product outlet 330. The drying system provided herein can include a horizontal plurality of conveyor systems, such as from 2 to 10 conveyor systems. An advantage of having more than two conveyors is that multiple drops from one conveyor to another can be achieved, which insures mixing of the dried dewatered cereal grass and even distribution of drying medium through the dried dewatered cereal grass as it moves through the drying chamber 300.

The cabinet 310 defining the drying chamber 300 can be constructed of any material or combination of materials that allow the environment within cabinet 300 to be separated from the external environment. For example, the cabinet 300 can include walls of wood, plastic, fiber glass composite, metal or combinations thereof. In some configurations, the cabinet 300 has wooden, aluminum or steel walls. The walls can be connected using any traditional fastening mechanism, such as screws, nails, glue, epoxy, ties, fasteners, angles, and combinations thereof. The drying chamber 300 can have an outlet connected to manifold 470 and an exhaust aperture 350. The drying medium can be moved through the drying chamber 300 using any traditional air moving devices, such as fans and blowers. In the systems provided herein, drying chamber 300 can include a treatment cycle 400 for conditioning the drying medium circulating through the drying chamber 300. In some configurations, the treatment cycle 400 connected to drying chamber 300 results in an essentially closed system, although some drying medium can be lost through imperfections in the construction material or seams of the cabinet.

Removal of moisture from the dewatered cereal grass is accomplished by passing a drying medium, such as dry air, nitrogen or inert gas, around the dewatered cereal grass as it enters that chamber 300 and through a layer of dewatered cereal grass on a conveyor as it passes through the chamber 300. For reasons of economy, air is the preferred drying medium, although nitrogen or an inert gas such as argon can be used. The drying medium can be driven through the treatment cycle using a blower unit 460. The blower unit 460 can include motor driven blower or fan or combinations thereof. The size and shape of the fan or blower can be selected to achieve a desired volume of air flow. One or more than one fan or blower can be used within the blower unit 460 to achieve the desired volume of drying medium flowing through the drying chamber 300. The blower unit 460 can include a damper for controlling flow rate of the drying medium. The blower unit(s) 460 can be placed anywhere within the air treatment cycle 400. In the configuration depicted in FIG. 6A, the blower unit 460 is positioned directly before manifold 470, although it also could have been positioned before or after heating device 440 or after inlet 410.

The interaction of the drying medium with the initially moist dewatered cereal grass results in the evaporation of moisture from the dewatered cereal grass, which results in the formation of cooler, moister drying medium due to the evaporation of moisture from the dewatered cereal grass. The now cooler, moister drying medium exits drying chamber 300 via exhaust aperture 350, which can be connected to be in fluid communication with inlet 410 of the treatment cycle 400. The cooler, moister drying medium is exposed to a cold heat exchanger 420 to condense water out of the drying medium, thus forming a dehumidified drying medium stream. The dehumidified drying medium stream then can be heated by a hot heat exchanger 430 resulting in a warmer, drier drying medium stream, which can be fed into drying chamber 300 via manifold 470.

In some applications, a refrigeration cycle (heat pump) is used as a heat exchanger. The cooler, moister drying medium venting from the drying chamber 300 via exhaust aperture 350 can be directed to a cold evaporator of a heat pump. Upon passing over the cold heat exchanger 420 of the heat pump, moisture in the drying medium condenses. The cold evaporator of the heat pump thereby extracts moisture and dries the drying medium. The cold and now drier drying medium then is directed toward a warm condenser 430 of the heat pump. Interacting with the warm condenser results in heated dry drying medium. The heated dry drying medium then is directed to the manifold 470 by the action of a fan or blower in blower unit 460, and the manifold 470 directs the warm dry drying medium through the drying chamber 300 extracting moisture from the dewatered cereal grass within the chamber, resulting in the formation of cooler moister drying medium, which is exhausted from the chamber 300 and into treatment cycle 400 to recirculate through the chamber and treatment cycle again.

In some configurations, the conveyor can include a mechanical mixer positioned above at least one portion of the conveyor. An exemplary configuration is shown in FIG. 6B. In the configuration shown, the mechanical mixer 360 is positioned above conveyor 315. The mechanical mixer 360 includes a rotating wheel 365 that rotates about a central axis 370. The wheel 365 includes a plurality of projections 375, such as hook or talon-like extensions. The rotating wheel 365 can be positioned so that the projections 375 can engage with the dewatered cereal grass on the conveyor, picking up at least a portion of the dewatered cereal grass from the conveyor and flipping it over by bringing it up and over the rotating wheel in a circular motion. The rotating wheel 365 can include mechanical, pneumatic or hydraulic actuators to position the wheel 365 closer to or further away from the conveyor 315. This mixing of the crop can further reduce drying time by mitigating wet spots or thick patches on the conveyor, and by exposing different surfaces to the drying medium. In the configuration shown, the rotating wheel 365 includes projections 375 around only a portion of the circumference to allow some material to pass beneath the wheel 365 without engaging with the projections 375 and being picked up by the rotating wheel 365. A second rotating wheel 365′ is positioned upstream from the first rotating wheel 365. The second rotating wheel 365′ includes projections around only a portion of the circumference. The rotation of rotating wheels 365 and 365′ is timed so that material that passes beneath wheel 365 without being picked up and turned by the projections 375 on wheel 365 is picked up and turned by the projections 375′ on wheel 365′.

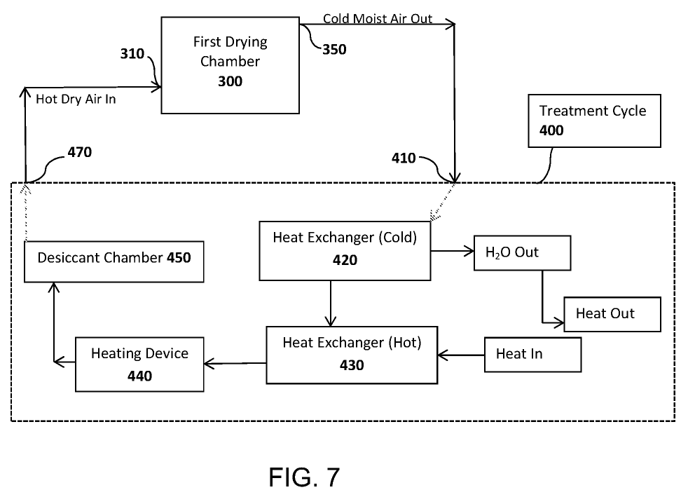

The treatment cycles of the drying systems provided herein can include additional components. In some configurations, the treatment cycle can include one or a combination of heating devices. In some configurations, the treatment cycle can include one or more desiccant chambers. In some configurations, the treatment cycle can include one or more air compressors. In some configurations, the treatment cycle can include at least one heating device and at least one desiccant chamber. In the exemplary configuration shown in FIG. 7, the treatment cycle 400 includes a heat exchanger having a cold heat exchanger 420 and a hot heat exchanger 430 over which the drying medium can pass to be dehumidified and heated. The treatment cycle 400 also includes a heating device 440 that can be used to further increase the temperature of the drying medium, and a desiccant chamber 450 that can further decrease the amount of moisture in the drying medium. Placement of the heating device 440 relative to the desiccant chamber 450 is not critical. The heating device 440 can be placed before or after the desiccant chamber 450 in the treatment cycle 400.

When present, the desiccant chamber in the treatment cycle includes a desiccant material to remove moisture from the drying material. Any desiccant material capable of removing moisture from the drying medium can be used. Exemplary desiccant materials include silica gel, a zeolite, bauxite, bentonite clay, montmorillonite clay, calcium chloride, calcium oxide, calcium sulfate, and magnesium sulfate. Many desiccants can be regenerated by driving off the absorbed moisture by heating, without or without vacuum treatment. The desiccant material can be provided in any form, such as powder, granules, bars, rods, or spheres, and can include an indicator that changes color when the desiccant material is saturated with moisture.

As depicted schematically in FIG. 7, after passing through the treatment cycle 400, the warm dry drying medium can enter drying chamber 300 via an inlet 310. The drying medium passes through the chamber, absorbing moisture from the dewatered cereal grass and exits the chamber via exhaust aperture 350, where it is directed to treatment cycle 400, which it can enter via inlet 410, is reconditioned, and can begin the cycle anew.

It may be desirous to provide a drying medium having a temperature greater than ambient temperature. The heat exchanger typically can be used to provide a drying medium having a temperature, measured at the intake 310 of drying chamber 300, in the range from about 60° C. to about 160° C. for drying the dewatered cereal grass, with minimum loss of nutrients. The drying system 1000 can include multiple heat pump cycles to achieve the desired temperature of the drying medium at the inlet 310 of the drying chamber 300. Optional heating devices can be included to provide additional thermal energy to heat the drying medium. In the embodiment illustrated schematically in FIG. 7, a heating device 440 is shown in the treatment cycle 400 after the hot heat exchanger 430 and before desiccant chamber 450. The placement of the optional heating device in the treatment cycle is not critical. It is illustrated positioned after the hot heat exchanger 430. Any type of heating device can be used. Exemplary heating devices include resistance heaters, electric air heaters, conductance heaters, convection heaters, infrared heaters, microwave air heaters, induction heaters and combinations thereof.

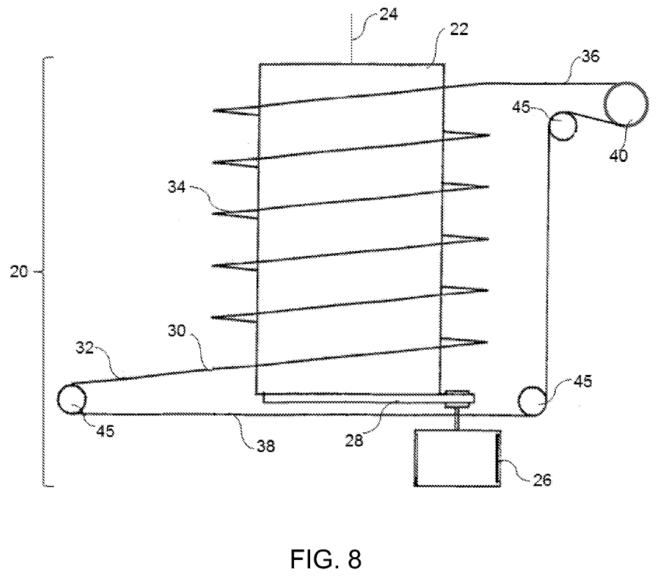

Although the dryer chamber 300 depicted in FIG. 6A is shown with an inclined conveyor 315 for collecting the incoming freely falling dewatered cereal grass, alternatively configured conveyors could be used for collecting the incoming dewatered cereal grass, such as a sequence of horizontally placed conveyors and spiral conveyor systems and combinations thereof, alone or in combination with inclined conveyors. An example of a spiral conveyor is shown in FIG. 8. As illustrated in the figure, a central drum 22 can be rotated about its vertical axis 24 by any convenient means, such as an electric motor 26 moving a drive chain 28. The spiral conveyor system 20 includes a perforated conveyor belt 30 that allows drying medium to pass through, and is configured to have a receiving area 32, a spiral portion 34, an end run 36 and a return 38. The conveyor belt 30 is driven by a motor 40. A plurality of pulleys 45 can be used to shape conveyor belt 30 into a desired path. The conveyor system can be an upward spiral as illustrated in FIG. 8, or can be configured as a down spiral. Some configurations can include an up spiral and a down spiral, with the end run of one feeding the receiving area of the other.

Referring to FIG. 8, spiral conveyor system 20 can receive the freely falling dewatered cereal grass on receiving area 32, where it forms a loose mat. The loose mat of dewatered cereal grass on the perforated conveyor is conveyed up the ascending conveyor belt, moving about a central drum which contains a series of distribution channels having opening slots that are positioned toward the conveyor belt. Warm dry drying medium from treatment cycle 400 can be conveyed to the interior of the central drum and out of distribution channels via the opening slots positioned below the conveyor belt and directed upward toward the underside of the conveyor belt. The warm dry drying medium coming out of the slots percolates upwardly through the perforated conveyor and the layer of dewatered cereal grass on the perforated conveyor belt. When the dewatered cereal grass reaches the end of the conveyor at the top of the spiral, it can deposited on the first of a series of horizontal conveyor belts of a horizontal conveyor system.

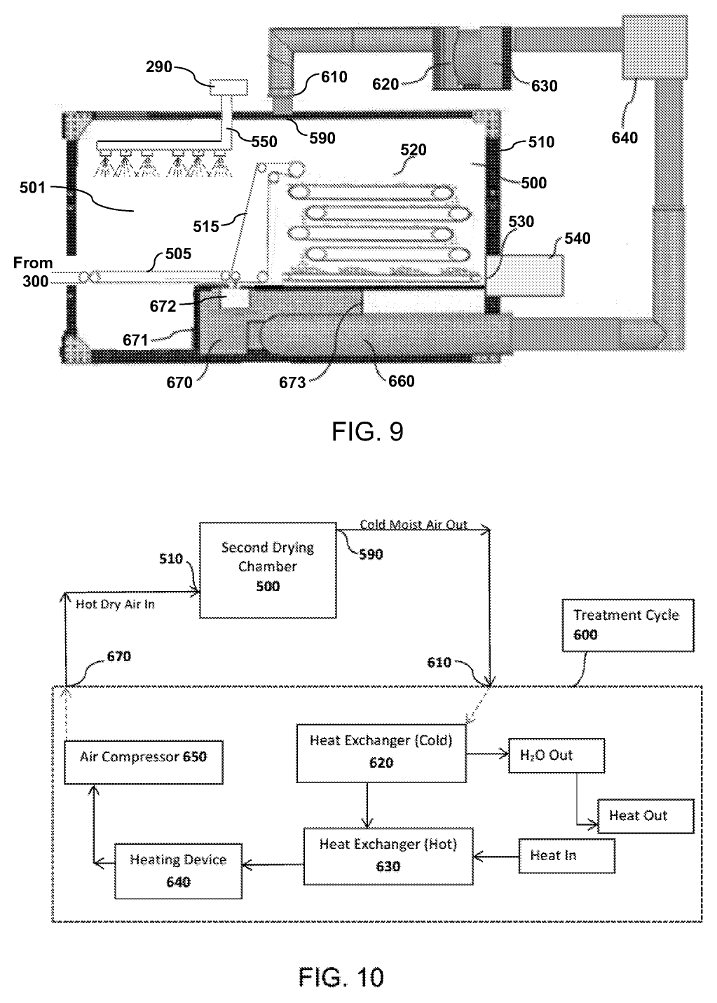

An exemplary second drying chamber is depicted in FIG. 9. Dried dewatered cereal grass from first drying chamber 300 is directed into second drying chamber 500, typically via a conveyor. A perforated conveyor 505 within drying chamber 500 accepts the incoming dried dewatered cereal grass and moves it along under a string of atomizers 550, which are connected to container 290, receiving the expressed grass liquid from container 290 and any additives added to the expressed grass liquid and converting the expressed grass liquid and any additives therein into a fine mist of droplets.

Drying medium is blown into chamber 500 via outlet 671 of manifold 670, flowing countercurrent to the fine mist of droplets of expressed grass liquid produced by the atomizers 550. In the configuration shown, the atomizer 550 is located near the top of the chamber 500 so that the droplets produced by the atomizer 550 fall downward through the drying medium toward the dewatered dried cereal grass on conveyor 505, while the flow of drying medium in the chamber in the zone of application 501 moves from the bottom to the top of the chamber in an upward direction, counter to the downward flow of the droplets. The small droplets of the expressed grass liquid fall countercurrent through the drying medium in the application zone 501 of the chamber. Due to the action of the drying medium through which the droplets pass, the liquid in the small droplets of the expressed grass liquid evaporates, partially or completely, to produce a condensed grass extract, which then falls onto and at least partially coats the dewatered dried cereal grass as it moves on motorized conveyor 505 yielding a coated cereal grass.

When the coated cereal grass reaches the end of conveyor 505, it is transferred to conveyor system 515. Conveyor system 515, as depicted in FIG. 9, includes a conveyor that transports the coated cereal grass product towards the top of chamber 500. Under conveyor 515 is outlet 672 of manifold 670, which directs a separate stream of dry warm drying medium upward through the conveyor 515 and the mat of coated cereal grass on the conveyor 515, removing any moisture added to the surface of the cereal grass by the adhered droplets of expressed grass liquid. At the end of conveyor 515, the dried coated cereal grass is transferred to a bank of horizontally arranged perforated conveyors of conveyor system 520, positioned so that the direction of the conveyors alternate in direction in order to maximize the drying time within the chamber using a minimum of space. Outlet 673 of manifold 670 is located under the bank of horizontally arranged perforated conveyors of conveyor system 520 and blows drying medium through the perforated conveyor through the bottom and through the mat of coated cereal grass on the conveyor, causing moisture in the coated cereal grass to evaporate, thereby reducing the moisture content of the coated cereal grass.

In the configuration shown in FIG. 9, the first conveyor belt of system 520 near the top of chamber 500 accepts dried coated cereal grass from conveyor 515 and transports it away from conveyor 515. When the dried coated cereal grass reaches the end of the first conveyor belt of conveyor system 520, the dried coated cereal grass falls down to conveyor belt directly underneath it, which moves in a direction toward conveyor 515. When the dried coated cereal grass reaches the end of this second conveyor belt, the dried coated cereal grass falls down to a third conveyor belt under the second belt. The direction of the third belt is opposite to that of the belt directly above it. This continues until the dried coated cereal grass reaches the end of the last conveyor of conveyor system 520. The drying chamber 500 can include a horizontal plurality of conveyor systems, such as from 2 to 10 conveyor systems. An advantage of having more than two conveyors is that multiple drops from one conveyor to another can be achieved, which insures mixing of the dried coated cereal grass and even distribution of drying medium through the dried coated cereal grass as it moves through the drying chamber 500.

The cabinet 510 defining the drying chamber 500 can be constructed of any material or combination of materials that allow the environment within cabinet 510 to be separated from the external environment. For example, the cabinet 510 can include walls of wood, plastic, fiber glass composite, metal or combinations thereof. In some configurations, the cabinet 510 has wooden, aluminum or steel walls. The walls can be connected using any traditional fastening mechanism, such as screws, nails, glue, epoxy, ties, fasteners, angles, and combinations thereof. The drying chamber 500 can have an inlet connected to manifold 670 and an exhaust aperture 590. The drying medium can be moved through the drying chamber 500 using any traditional air moving devices, such as fans and blowers. Drying chamber 500 can include a treatment cycle 600 for conditioning the drying medium circulating through the drying chamber 500. In some configurations, the treatment cycle 600 connected to drying chamber 500 results in an essentially closed system, although some drying medium can be lost through imperfections in the construction material or seams of the cabinet 510.

The drying medium can be driven through the treatment cycle 600 using a blower unit 660. The blower unit 660 can include a motor-driven blower or fan or combinations thereof. The size and shape of the fan or blower can be selected to achieve a desired volume of air flow. One or more than one fan or blower can be used within the blower unit 660 to achieve the desired volume of drying medium flowing through the drying chamber 500. The blower unit 660 can include a damper for controlling flow rate of the drying medium. The blower unit(s) 660 can be placed anywhere within the air treatment cycle 600. In the configuration depicted in FIG. 9, the blower unit 660 is positioned directly before manifold 670, although it also could have been positioned before or after heater 640 or after inlet 610.

The interaction of the drying medium with the droplets from the atomizer 550 and the coated cereal grass results in the evaporation of moisture from the droplets and the coated cereal grass, which results in the formation of cooler, moister drying medium. The now cooler, moister drying medium exits drying chamber 500 via exhaust aperture 590, which can be connected to be in fluid communication with inlet 610 of the treatment cycle 600. The cooler, moister drying medium is exposed to a cold heat exchanger 620 to condense water out of the drying medium, thus forming a dehumidified drying medium stream. The dehumidified drying medium stream then can be heated by a hot heat exchanger 630 resulting in a warmer, drier drying medium stream, which can be fed into drying chamber 500 via manifold 670.

The treatment cycle 600 of the drying chamber 500 can include additional components. In the exemplary configuration shown in FIG. 10, the treatment cycle 600 includes a heat exchanger having a cold heat exchanger 620 and a hot heat exchanger 630 over which the drying medium can pass to be dehumidified and heated. The treatment cycle 600 also includes a heating device 640 that can be used to further increase the temperature of the drying medium, and an air compressor 650 that can further decrease the amount of moisture in the drying medium. The dried warmed drying medium can exit the treatment cycle 600 via manifold 670, which can be connected to inlet 510 of the second drying chamber.

Referring back to FIG. 9, once the dried coated cereal grass reaches the end of conveyor system 520, if the targeted moisture level of the coated cereal grass has been achieved, the dried coated cereal grass can exit chamber 500 and be transferred to dry product collection unit 700 for final processing, such as baling using traditional baling equipment and techniques. If the targeted moisture level of the coated cereal grass has not been achieved when the dried coated cereal grass reaches the exit 530 of drying chamber 500, or an additional optional treatment is to be performed, the dried coated cereal grass can be transferred to drying chamber 800 for further processing. The exit 530 can be joined to a connector 540 that can connect the second drying chamber to a third drying chamber 800 or to the dry product collection unit 700.

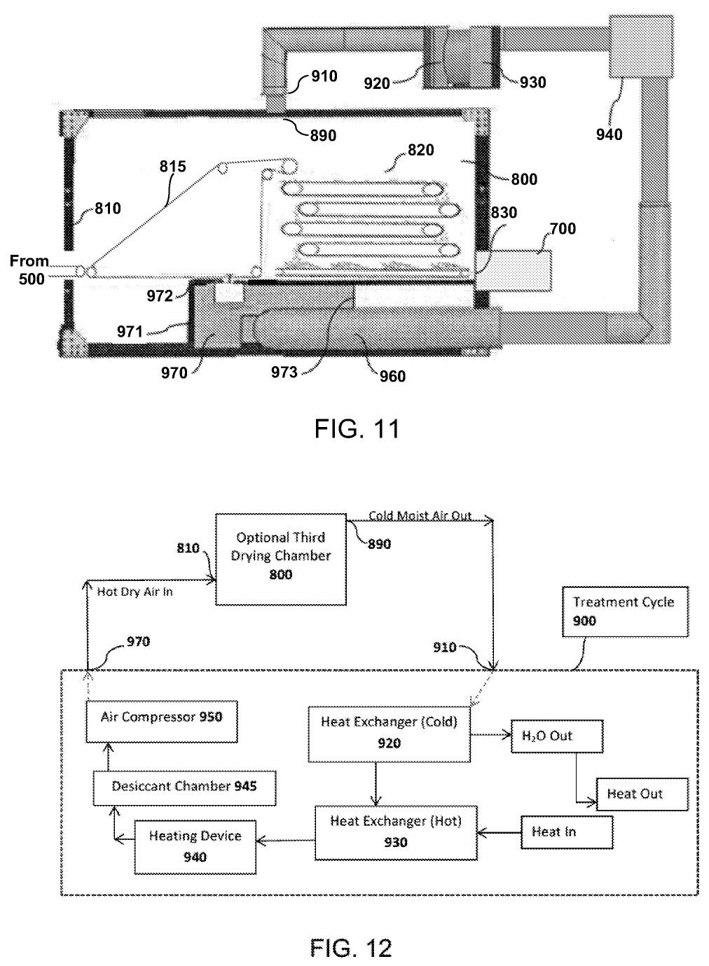

An exemplary configuration of drying chamber 800 is depicted in FIG. 11. Dried coated cereal grass from drying chamber 500 is transferred to conveyor belt 815, forming a loose mat of dry coated material. The conveyor belt 815 is perforated and allows dry drying medium from manifold outlets 971 and 972 to pass through the conveyor belt 815 up through the mat of dry coated material.

Manifold outlet 972 in positioned beneath the perforated conveyor 815 and blows a separate stream of drying medium through the pile of coated cereal grass as it moves upward on the perforated conveyor 815 toward the top of the chamber 800. At the end of perforated conveyor 815, the coated cereal grass is deposited onto the first of a sequence of horizontally arranged perforated conveyor belts 820. Manifold outlet 973 blows a stream of drying medium through the perforated conveyor belts 820 to remove additional moisture from the coated cereal grass as it traverses perforated conveyor belts 820. The speed of the conveyor belts, the flow of the drying medium, and the number of conveyor belts 820 can be adjusted to yield a dried dewatered cereal grass having a targeted moisture content. The drying medium injected through manifold outlet 973 can have a moisture content equal to the targeted moisture content of the final dried coated cereal grass and can be used to condition the dried coated cereal grass to make sure that the moisture content does not fall below a critical amount of moisture.

In the configuration depicted in FIG. 11, conveyor system 815 includes a belt forming a loop over five rollers to form a continuous loop. Any of the rollers can be connected to a variable speed motor, the movement of which results in movement of the conveyor belt. Coated cereal grass is transported upwardly by conveyor system 815 to a bank of horizontally arranged conveyors of conveyor system 820, positioned so that the direction of the conveyors alternate in direction in order to maximize the drying time within the chamber using a minimum of space. In the configuration shown in FIG. 9, the first conveyor belt of system 820 near the top of chamber 800 accepts dried coated cereal grass from conveyor 815 and transports it away from conveyor 815. When the dried coated cereal grass reaches the end of the first conveyor belt of conveyor system 820, the dried coated cereal grass falls down to conveyor belt directly underneath it, which moves in a direction toward conveyor 815. When the dried coated cereal grass reaches the end of this second conveyor belt, the dried coated cereal grass falls down to a third conveyor belt under the second belt. The direction of the third belt is opposite to that of the belt directly above it. This continues until the dried coated cereal grass reaches the end of the fifth conveyor belt, where it exits chamber 800 via exit 830. The drying system provided herein can include a horizontal plurality of conveyor systems, such as from 2 to 10 conveyor systems. An advantage of having more than two conveyors is that multiple drops from one conveyor to another can be achieved, which insures mixing of the dried dewatered cereal grass and even distribution of drying medium through the dried dewatered cereal grass as it moves through the drying chamber 800. The dried coated cereal can be transferred to dry product collection unit 700 for final processing, such as baling using traditional baling equipment and techniques.

The cabinet 810 defining the drying chamber 800 can be constructed of any material or combination of materials that allow the environment within cabinet 810 to be separated from the external environment. For example, the cabinet 810 can include walls of wood, plastic, fiber glass composite, metal or combinations thereof. In some configurations, the cabinet 810 has wooden, aluminum or steel walls. The walls can be connected using any traditional fastening mechanism, such as screws, nails, glue, epoxy, ties, fasteners, angles, and combinations thereof. The drying chamber 800 can have an inlet connected to manifold 970 and an exhaust aperture 890. The drying medium can be moved through the drying chamber 800 using any traditional air moving devices, such as fans and blowers. Drying chamber 800 can include a treatment cycle 900 for conditioning the drying medium circulating through the drying chamber 800. In some configurations, the treatment cycle 900 connected to drying chamber 800 results in an essentially closed system, although some drying medium can be lost through imperfections in the construction material or seams of the cabinet 810.

The drying medium can be driven through the treatment cycle 900 using a blower unit 960. The blower unit 960 can include motor driven blower or fan or combinations thereof. The size and shape of the fan or blower can be selected to achieve a desired volume of air flow. One or more than one fan or blower can be used within the blower unit 960 to achieve the desired volume of drying medium flowing through the drying chamber 800. The blower unit 960 can include a damper for controlling flow rate of the drying medium. The blower unit(s) 960 can be placed anywhere within the air treatment cycle 800. In the configuration depicted in FIG. 11, the blower unit 960 is positioned directly before manifold 970, although it also could have been positioned before or after heating device 940 or after inlet 910.

The interaction of the drying medium with the dried coated cereal grass results in the evaporation of moisture from the coated cereal grass, which results in the formation of cooler, moister drying medium. The now cooler, moister drying medium exits drying chamber 800 via exhaust aperture 890, which can be connected to inlet 910 of the treatment cycle 900. The cooler, moister drying medium is exposed to a cold heat exchanger 920 to condense water out of the drying medium, thus forming a dehumidified drying medium stream. The dehumidified drying medium stream then can be heated by a hot heat exchanger 930 resulting in a warmer, drier drying medium stream, which can be fed into drying chamber 800 via manifold 970.

The treatment cycle 900 of the drying chamber 800 can include additional components. In the exemplary configuration shown in FIG. 12, the treatment cycle 900 includes a heat exchanger having a cold heat exchanger 920 and a hot heat exchanger 930 over which the drying medium can pass to be dehumidified and heated. The treatment cycle 900 also includes a heating device 440 that can be used to further increase the temperature of the drying medium, and a desiccant chamber 945 and an air compressor 950 that can further decrease the amount of moisture in the drying medium. The dried warmed drying medium can exit the treatment cycle 900 via manifold 970, which can be connected to inlet 805 of the third drying chamber 800.

There are numerous ways known to those of ordinary skill in the art to provide rotational drive to the conveyor belts and rollers, such as motors and engines, or any other source of power to facilitate rotation, none of which in particular is required to practice this invention. All of the components described above are commercially available. They have, however, been combined to create a unique processing system in accordance with the teachings of the methods and systems described herein.

The drying system provided herein can include a portable housing supported on wheels allowing the system to be mobile and easily transported. The housing can include any framework or structure that directly or indirectly supports the components of drying system. The housing is not limited to any specific embodiment or configuration.

The drying systems provided herein can be configured to mobile, such as being mounted on a movable bed or trailer, so that the system can be moved behind a combine, and freshly mowed agricultural product can be deposited directly into the drying system. This can allow the moist agricultural product to be processed at about the same rate that it is conventionally harvested. This configuration can provide the least amount of impact on conventional harvesting methods, and can be more readily accepted by farmers. The drying systems provided herein also can be designed to be mobile so that they are sufficiently portable to move from farm to farm. Although mobile, the systems can be used in a stationary configuration once on site. For example, once transported to a farm, the system can be immobilized and agricultural product harvested conventionally can be transported to the drying system for drying, and once dried, transferred to baling equipment for baling.

For mobile configurations, a connector for attaching the dryer system to a tractor can be provided. The connector typically is made of metal. In some applications, the connector is a steel, such as low carbon steel, high carbon steel, alloy steel (containing one or a combination of a metal selected from among of aluminum, chromium, copper, manganese, molybdenum, nickel, titanium, tungsten and vanadium), stainless steel or tool steel (typically a high-hardness steel that is resistant to abrasion). The connector can be designed to provide sufficient mobility and play to compensate for large dips or other irregularities in the ground. For mobile configurations, electrical connections can be reinforced with additional insulation are configured to run through a passageway within the connector. Typically, steel framing is used to support the weight of the components of the dryer. Four or more large rubber grooved tires to traverse over rough terrain and mitigate mobility maintenance typically are used. The tires can be pneumatic. The tires can include a tire tube (inner tube) to prevent air leakage or to extend the life of the tire.

The drying systems provided herein can include a scale to measure the weight of the crop during processing. For example, one or more scales under the second set of rollers in the first drying chamber can measure the weight of material as it is deposited into the chamber. Data from the scales can be used to determine mass throughput.

### C. METHODS

Also provided herein are methods of drying moist agricultural products, particularly fresh cut cereal grass and other forage crops. A drying medium, such as air, nitrogen or an inert gas such as argon, is dried in a treatment cycle by reducing its relative humidity by passing it over a cold evaporator of a heat pump, or through a desiccant chamber, or through a compressor, or any combination thereof, which reduces the amount of moisture in the drying medium. For example, upon passing over the cold evaporator of a heat pump, moisture in the drying medium condenses out of the drying medium, resulting in a cool dried drying medium. The cool and now drier drying medium then can be directed toward a warm condenser of the heat pump. Interacting with the warm condenser results in a warmer dried drying medium. The warmer dried drying medium then is directed to a blower unit, which directs the warmer dried drying medium through a drying chamber through which the agricultural product traverses. Traversing the drying chamber results in the warmer dried drying medium evaporating moisture from the cereal grass or forage crop, thereby extracting moisture from the cereal grass or forage crop, resulting in dried cereal grass or forage crop and the formation of a cooler moister drying medium. The method then includes directing the cooler moister drying medium over a cold evaporator of a heat pump, whereby the drying medium treatment cycle begins again.

The drying systems and methods provided herein can significantly shorten the harvest process and can increase the effective growing time of an agricultural product. By significantly shortening the drying time, a longer effective growing season can be achieved. Based on initial calculations, it may be possible to reduce harvest times from about 30% of the growing season to about 7%. This would increase the effective growing time from about 70% of the season to about 93%, meaning there could be at least one and possibly two extra harvests depending on geographical region. These extra harvests could produce about 23% higher crop yield per season.

Crop loss due to inclement weather, especially during harvesting, is another problem farmers face, more so for farmers in wetter climates than farmers in drier climates. The drying systems and methods provided herein can remove the dependence on natural drying, thus minimizing or eliminating the need to schedule harvests around inclement weather. The systems and methods for drying agricultural products provided herein also can help to minimize or eliminate the risk of crop loss due to unexpected inclement weather during harvesting. Because the drying systems and methods provided herein do not depend on the vagaries of weather, it can be possible to expand the growing range of certain agricultural products, such as alfalfa, into more humid and wet climates than traditionally are used because of prior dependence on the weather to remove moisture from the crop. The drying systems and methods provided herein can reduce the need for growth in a dry climate to effectively dry forage crops. The systems and methods provided herein can allow these forage crops to be grown in geographical regions with more water and cheaper farmland.

Using the drying systems and methods provided herein can allow a farmer to eliminate the tedding and raking processes traditionally required in drying forage crops using the sun and wind. The tedding and raking processes can be some of the most expensive processes in the harvest process, because they can lead to high mechanical crop loss. In some studies, mechanical crop loss can be typically 5% of the final mass yield when measured with respect to wet crops, and up to 15% when measured with respect to dry crops. By eliminating the need for tedding and raking processes, mechanical losses due to these processes can be eliminated, directly increasing the total crop yield per harvest.

The invention also relates to a method of drying cut cereal grass or other forage crop. The inventive method comprises passing the cereal grass or forage crop through at least a first nip formed between a first roll and a second roll such that liquid in the cereal grass or other forage crop is pressed out of the cereal grass or other forage crop when the cereal grass or other forage crop passes through the first nip. In the methods provided herein, the liquid that has been pressed out of the cereal grass or other forage crop is collected, such as by aspiration by a suction device. The collected expressed liquid from the cereal grass or other forage crop then is directed to an atomizer, which transforms the liquid into a fine mist of droplets, that pass through a drying medium in a drying chamber, causing the liquid in the droplets to evaporate, concentrating or drying the droplets, which are then deposited on the dewatered cereal grass or other forage crop inside the drying chamber to form a coated cereal grass or other forage crop. The suction device can be positioned/arranged such that it sealingly engages an outer surface of the first roll such that a delimited suction zone is formed in the area between the at least one suction device and the outer surface of the first roll, and the suction device is operated during pressing such that a reduced pressure or an underpressure is produced in the delimited suction zone. Any nutrients that may have been expressed with the liquid pressed out of the cereal grass or forage crop as it passes through the at least one nip are returned via the atomizer, coating and dried cereal grass or forage crop, resulting in a dried coated product containing substantially the same nutritive value as a traditionally dried cereal grass or forage crop.

In the methods provided herein, the liquid collected upon pressing of the cereal grass or forage crop in the first nip can be mixed with one or more nutrients or additives or both before being atomized. For example, the method can include as a step mixing a nutrient or an additive or a combination thereof into the collected expressed liquid pressed from the cereal grass or forage crop, atomizing the mixture in a drying chamber to form droplets, passing the droplets through a drying medium to reduce the moisture level of the droplets, and depositing the resulting droplets onto the dewatered cereal grass or forage crop to form a coated cereal grass product or coated forage crop product. For example, any one or a combination of the following can be added to the expressed grass liquid prior to atomizing the expressed grass liquid: corn steep liquor, barley extract, yeast extract, waste from beer fermentation broth, molasses, enzymes such as phytases and glycanases, ionophores such as monensin sodium (Rumensin®) and lasalocid sodium (Bovatec®), probiotics including certain strains of Bifidobacterium, Enterococcus, Bacillus, and Lactobacillus, sodium bicarbonate, sodium sesquicarbonate, zinc methionine, a vitamin, an oil, a fatty acid, a fat, a mineral, an amino acid, a phospholipid, an anti-oxidant, and an agent to prevent biological contamination. In the methods provided, nutrients and/or additives can be coated onto the cereal grass or forage crop as the cereal grass or forage crop is being processed through the drying system, producing a coated product in a single process. The drying system can be operated as a batch process or as a continuous process.

In the methods provided herein, a pretreatment of the crop prior to or during harvest prior to entry of the cut crop into the dryers provided herein can be included. A chemical conditioner can be applied to the crop in order to quicken drying rates. For example, any waxy cuticle or hydrophobic surface can act as a barrier to water transport out of the cereal grass. A chemical conditioner can be used to disrupt the waxy cuticle in order to accelerate drying. In some implementations of the method, a desiccant solution can be applied. Examples of desiccant solutions include aqueous solutions of potassium carbonate, sodium carbonate, sodium hydroxide and combinations thereof. The desiccant typically is present in an amount of from about 1 wt % to about 5 wt % based on the total weight of the composition. Tests have shown that crop drying rates can be increased by applying as little as 55 gallons of 2-4% solution per acre. Chemical conditioning systems typically use spray nozzles for uniform application to the crop material. The spray nozzles can be positioned so that the desiccant solution is applied just before the crop enters the conditioner rollers.

The conditioner rollers can facilitate the faster drying of the crop by crimping, crushing and/or fracturing the stem of the cereal grass or forage crop to facilitate removal of the moisture in the product. Conditioners typically include two or more elongated parallel rollers, slightly spaced apart from one another. The respective adjacent rollers rotate in opposite directions from one another. Agricultural product such as cereal grass or forage crop is fed through the gap between the two rollers. The roller surface typically has raised intermeshing portions to further the gripping or crimping of the crop. Other conditioners use impact style rotors with outwardly extending projections to further assist in the crimping of the crop. After passing through the conditioner rollers, the crushed/crimped material is passed along to pressing rollers to accomplish a pressing step.

The pressing step is an important step for the drying of the cereal grasses or forage crops, because liquid removal in the subsequent drying steps is much more energy intensive. The pressing step expresses liquid from the cereal grasses or forage crops and can minimize energy consumption by reducing the moisture within the cereal grass or forage crop. The dewatered cereal grass or forage crop has a reduced water and natural liquid content. In some applications, the moisture content of the cereal grass or forage crop after pressing can be in the range from about 25 to about 30% by weight. This results in a reduction in the time and energy required to subsequently dry the cereal grass to a desired moisture content, such as from about 16% to about 22%.

Although described using rolls to extract the liquid, the system can be modified to use a hydraulic press, a screw press or a belt press to express the liquid from the cereal grass or forage crop.

The methods provided herein also can include as a step passing the cut cereal grass or forage crop through a covered set of rolls to remove surface moisture from the cereal grass of forage crop. This step enables the end user to harvest a crop early in the day when dew or other condensation may be present on the crop. It also can allow the end user to harvest a crop immediately after a rain, since surface moisture on the crop can be removed by the covered rolls. The moist cereal grass or forage crop is passed through at least a first nip formed between a first covered roll and a second covered roll such that surface moisture on the cereal grass or other forage crop is absorbed or wicked away by the coverings on the rolls when the cereal grass or other forage crop passes through the first nip.

While exemplary embodiments are described as including separate drying chambers, in some configurations, the drying system can be provided contained within a single chamber containing multiple zones. In one configuration, a single chamber can include a first drying zone, a second drying zone and optionally a third drying zone. The chamber can include one or a plurality of drying medium inlets. The chamber can include one or a plurality of drying medium outlets. The chamber can include baffles for directing the drying medium within the chamber, toward or away from any given baffle. The chamber can include a plurality of atomizers.

While various embodiments of the subject matter provided herein have been described, it should be understood that they have been presented by way of example only, and not limitation. Since modifications will be apparent to those of skill in this art, it is intended that this invention be limited only by the scope of the appended claims.

### LIST OF FIGURE ELEMENTS

20 Spiral conveyor system

22 Central drum

24 Vertical axis

26 Electric motor

28 Drive chain

30 Conveyor belt

32 Receiving area

34 Spiral portion

36 End run

38 Return

40 Motor

45 Pulley

50 Pre-treatment rolls

52 First roll having a covering (covered roll)

53 Covering

55 Second roll having a covering (covered roll)

56 Covering

60 Nip formed by covered roll 52 and covered roll 55

62 Dewatering roll

63 Suction device

65 Dewatering roll

66 Suction device

68 Suction device

70 Central axis

71 Central axis

72 Nip formed by dewatering roll 62 and covered roll 52

74 Nip formed by dewatering roll 65 and covered roll 55

75 Chemical applicator

80 Supply line

85 Metering pump

90 Frame

95 Spray nozzle

100 Conditioner unit

110 Conditioner roll

115 Conditioner roll

120 Frame

200 Second set of rolls (pressing rolls)

210 First roll of second set of rolls

220 Second roll of second set of rolls

230 Nip formed by roll 210 and roll 220

240 Suction device

245 Suction device

250 Suction device

255 Suction device

280 Central axis

285 Central axis

290 Container

300 First drying chamber

305 Product inlet

310 Cabinet

315 Perforated conveyor

320 Perforated conveyor system

330 Product outlet

340 Connector

350 Exhaust aperture

360 Mechanical mixer

365 Rotating wheel

370 Axis

375 Projections

400 Treatment cycle

410 Treatment cycle inlet

420 Cold heat exchanger

430 Hot heat exchanger

440 Heating device

450 Desiccant chamber

460 Blower unit

470 Manifold

471 Manifold outlet

472 Manifold outlet

473 Manifold outlet

500 Second drying chamber

501 Zone of application

505 Motorized conveyor

510 Cabinet

515 Perforated conveyor

520 Perforated conveyor system

530 Exit

540 Connector

550 Atomizer

590 Exhaust aperture

600 Treatment cycle

610 Inlet

620 Cold heat exchanger

630 Hot heat exchanger

640 Heating device

650 Air compressor

660 Blower unit

670 Manifold

671 Manifold outlet

672 Manifold outlet

673 Manifold outlet

700 Dry product collection unit

800 Optional third drying chamber

805 Inlet

810 Cabinet

815 Perforated conveyor

820 Perforated conveyor system

830 Exit

890 Exhaust aperture

900 Treatment cycle

910 Inlet

920 Cold heat exchanger

930 Hot heat exchanger

940 Heating device

945 Desiccant chamber

950 Air compressor

960 Blower unit

970 Manifold

971 Manifold outlet

972 Manifold outlet

973 Manifold outlet

1000 Drying system

1. A system for drying a cereal grass or forage crop, comprising:
a conditioner comprising:
a) a set of grooved or ribbed rollers that interact to crimp or to crush or to crimp and crush the cereal grass or forage crop; or
b) a first roll and a second roll having ribs and grooves of a similar configuration reversed end for end, the ribs of the first roll intermeshing with the grooves of the second roll to crimp or to crush or to crimp and crush the cereal grass or forage crop;
a first pressing roll and a second pressing roll that form a nip therebetween through which the cereal grass or forage crop can be pressed, pressing the liquid out of the cereal grass or forage crop to form a first product stream comprising a dewatered cereal grass or forage crop and a second product stream comprising liquid pressed out of the cereal grass or forage crop;
at least one suction device comprising a vacuum system for collecting the second product stream;
a drying chamber comprising:
a drying medium intake aperture;
a drying medium exhaust aperture;
an inlet for receiving the first product stream; and
an outlet for discharging a dewatered cereal grass or forage crop;
a temperature sensor; and
a humidity sensor;
a first perforated conveyor comprising a variable speed electric motor and drive for moving the perforated conveyor that moves the cereal grass or forage crop through the drying chamber;
a circulation system comprising a fan or blower or both for moving the drying medium through the drying chamber;
a cabinet enclosing the drying chamber; and
an atomizer for atomizing the second product stream into droplets that pass through the drying medium and are deposited on the first product stream on a second perforated conveyor comprising a variable speed electric motor and drive unit for moving the first product stream beneath the atomizer within the drying chamber.

2-3. (canceled)

4. The system of claim 1, further comprising a pre-treatment roller unit comprising:
a first covered roll and a second covered roll that form a nip through which the cereal grass or forage crop can be passed to remove surface moisture, the first covered roll having a first covering and the second covered roll having a second covering;
a first suction device to remove liquid from the first covering; and
a second suction device to remove liquid from the second covering,
wherein:
at least one of the first suction device or second suction device extends in a direction parallel to the axis of the roll with which it is associated and sealingly engages an outer surface of the roll to form a delimited suction zone.

5. (canceled)

6. The system of claim 1, wherein at least one of the first pressing roll or the second pressing roll is a perforated roll shell comprising at least one suction device inside of the perforated roll shell to collect the second product stream.

7-12. (canceled)

13. The system of claim 1, wherein the drying chamber further comprises a treatment cycle for reconditioning the drying medium, wherein the treatment cycle comprises:
a) a heat exchanger; or
b) a heating device; or
c) a compressor; or
d) a desiccant chamber; or
e) any combination of a) to d).

14-21. (canceled)

22. The system of claim 1, further comprising:
a) a scale to measure the weight of the cereal grass or forage crop being deposited into the drying chamber; or
b) a cleaning system that comprises sprayers that can apply a cleaning solution to surfaces within the chamber of the system; or
c) a temperature sensor or a humidity sensor or both within the chamber.

23-26. (canceled)

27. The system of claim 1, further comprising:
a) an obstruction sensor to detect if any material becomes adhered to a roll, wherein the obstruction sensor comprises a pair of optical sensors mounted to project a beam of light of any wavelength across length of roller, that when interrupted by material adhered to the roller, will interfere with the transmission of the light beam of the optical sensor, indicating material is adhered to the surface of a roller; or
b) a gap adjuster that can adjust the size of the nip between the first pressing roll and the second pressing roll; or
c) a blade or brush to remove any material that becomes adhered to the roll; or
d) a jet spray that directs a high pressure air stream or water stream onto the surface of the rollers; or
e) any combination of a) to d).

28-29. (canceled)

30. The system of claim 27, wherein:
i) the obstruction sensor is in communication with the blade or brush or jet spray or any combination thereof to clear any obstruction from a roll surface; or
ii) the gap adjuster is in communication with:
a) a sensor measuring the rate of rotation of the pressing rolls, and a decrease or stop of rotation due to an accumulation of material between the rollers signals the gap adjuster to momentarily increase the gap between the rollers to allow any clumped material to pass; or
b) the obstruction sensor, blade, brush or jet spray, or a combination thereof; or
c) both a) and b).

31-33. (canceled)

34. The system of claim 1, further comprising a computer for partial or complete automation of the system, wherein the computer is in communication with, or in control of, or in communication with and in control of:
a) the conditioner; or
b) the pressing rollers; or
c) the vacuum system; or
d) the fan or blower of the drying chamber(s); or
e) the atomizers; or
f) the conveyors; or
g) the temperature sensor; or
h) the humidity sensor; or
i) any combination of a) through h).

35. (canceled)

36. The system of claim 34, wherein the computer comprises a non-transitory computer-readable storage medium having a computer-readable program embodied therein for directing operation of the drying system and/or any component of the drying system.

37. (canceled)

38. The system of claim 34, wherein the computer:
a) controls the flow and speed of the drying medium throughout the chamber(s); or
b) is in communication with temperature and/or humidity sensors within the chamber, and can adjust the flow of drying medium within the chamber in accord with predetermined temperature and humidity parameters; or
c) is programmed to be self-optimizing based on the sensors within the chamber and adjusts the temperature, speed and volume flow of drying medium through the chamber to optimize drying and efficiency of the system; or
d) includes a program that provides a selectable operational mode that allows selection of a type of crop to be processed, and the computer adjusts the components of the system to dry the type of crop designated; or
e) includes a program that can adjust the nip width and pressure according to an input description of the type of crop being processed; or
f) any combination of a) to e).

39. A method of drying a cut cereal grass or forage crop, comprising passing the cereal grass or forage crop through a system of claim 1.

40. A method of drying a cut cereal grass or forage crop, comprising:
passing the cereal grass or forage crop through a pressing nip formed between a first pressing roll and a second pressing roll such that a liquid in the cereal grass or other forage crop is pressed out of the cereal grass or other forage crop when the cereal grass or other forage crop passes through the first nip to form a first product stream comprising a dewatered cereal grass or a dewatered forage crop and a second product stream comprising the liquid pressed out of the cereal grass or forage crop;
subjecting the first product stream to a drying medium to reduce the moisture content of the first product stream to produce a dried first product stream;
atomizing the second product stream into droplets using an atomizer and passing the droplets through a drying medium over the first product stream to form condensed droplets that are deposited on the first product stream to yield a coated first product stream; and
subjecting the coated first product stream to a drying medium to reduce the moisture content of the coated first product stream to a targeted moisture content to yield a dried product.

41. The method of claim 40, wherein the second product stream is collected by aspiration using a suction device and transferred to a container and the second product stream is provided from the container to the atomizer using a pump.

42. (canceled)

43. The method of claim 40, wherein an additive is mixed into the second product stream prior to atomization, wherein the additive is selected from among a corn steep liquor, a barley extract, a yeast extract, waste from beer fermentation broth, molasses, an enzyme, an ionophore, a probiotic, sodium bicarbonate, sodium sesquicarbonate, zinc methionine, a vitamin, an oil, a fatty acid, a fat, a mineral, an amino acid, a phospholipid, an anti-oxidant, an agent to prevent biological contamination, and combinations thereof.

44. (canceled)

45. The method of claim 43, wherein:
a) the enzyme is a phytase or a glycanase; or
b) the ionophore is monensin sodium or lasalocid sodium; or
c) the probiotic is a strain of bacteria selected from among Bifidobacterium, Enterococcus, Bacillus, and Lactobacillus; or
d) the fatty acid comprises alpha-linolenic acid (ALA), eicosapentaenoic acid (EPA), or docosahexaenoic acid (DHA); or
e) the anti-oxidant comprises Vitamin E, a tocopherol, mixed tocopherols, a carotenoid, a polyphenolic compound, ascorbic acid, eugenol, thymol, green tea extract, rosemary oil or extract, thyme white oil, or combinations thereof; or
f) the agent to prevent biological contamination comprises acetic acid, ascorbic acid, benzoic acid, citric acid, phosphoric acid, propionic acid, sorbic acid, and salts, and combinations thereof; or
g) any combination of a) to f).

46. The method of claim 40, wherein:
the moisture content of the first product stream after passing through the pressing nip formed between the first pressing roll and the second pressing roll is in the range of from about 25% to about 30% by weight; and
the moisture content of the coated first product stream is in a range from about 16% to about 22% by weight.

47-53. (canceled)

54. The method of claim 40, further comprising passing the cereal grass or forage crop through a conditioner prior to the pressing nip, wherein the conditioner comprises:
a) a set of grooved or ribbed rollers that interact to crimp or to crush or to crimp and crush the cereal grass or forage crop; or
b) a plurality of equally circumferentially spaced ribs extending across the axial length of the roll, the ribs having a slope relative to the axis of the roll reversing from positive to negative at least once; or
c) ribs and the ribs are positioned to form a sinusoidal configuration; or
d) a first roll and a second roll having ribs and grooves of a similar configuration reversed end for end, the ribs of the first roll intermeshing with the grooves of the second roll.

55. (canceled)

56. The method of claim 40, further comprising:
i) after passing the cereal grass or forage crop through the pressing nip, treating the cereal grass or forage crop with hydrogen peroxide, an acid, a protease, a carbohydrase, a preservative, or a combination thereof; or
ii) treating the cereal grass or forage crop with a chemical solution prior to entering a conditioner, wherein the chemical solution comprises:
a) a chemical that disrupts the cuticle of the cereal grass or forage crop; or
b) a desiccant selected from among potassium carbonate, sodium carbonate, sodium hydroxide, and combinations thereof;
c) a C₁-C₅ alcohol; or d) any combinations of a) to c); or
iii) both i) and ii).

57-65. (canceled)
